(19) United States
(12) Patent Application Publication
(10) Pub. No.: US 2013/0022288 A1
(43) Pub. Date: Jan. 24, 2013

(54) IMAGE PROCESSING APPARATUS AND METHOD FOR REDUCING EDGE-INDUCED ARTEFACTS

(71) Applicants: Piergiorgio SARTOR, Fellbach (DE); Francesco MICHIELIN, Padova (IT)

(72) Inventors: Piergiorgio SARTOR, Fellbach (DE); Francesco MICHIELIN, Padova (IT)

(73) Assignee: Sony Corporation, Tokyo (JP)

(21) Appl. No.: 13/544,507

(22) Filed: Jul. 9, 2012

(30) Foreign Application Priority Data
Jul. 20, 2011 (EP) 11005948.2

(51) Int. Cl. G06T 5/00

(52) U.S. Cl. 382/266

(57) ABSTRACT

The present invention relates to image processing. A wavelet decomposition unit (110) applies a wavelet decomposition on an image or video data signal and generates approximation and detail signals. A discontinuity detection unit (120) detects discontinuities like block boundaries and/or image contour lines in an evaluation signal selected from the approximation and detail signals. An artefact reduction unit (140) reduces edge-induced artefacts by equalizing pixel values in image areas identified by the detected discontinuities in one or more of the approximation and detail signals to obtain at least one corrected approximation or detail signal. The corrected approximation and detail signals support a reconstruction of the image data signal, wherein the reconstructed image shows reduced blocking and ringing artefacts.

### CROSS REFERENCE TO RELATED APPLICATION

The present application claims the benefit of the earlier filing date of 11 005 948.2 filed in the European Patent Office on Jul. 20, 2011, the entire content of which application is incorporated herein by reference.

### FIELD OF INVENTION

Embodiments of the present invention relate to an image processing apparatus and a method for reducing artefacts in an image signal or in a video signal comprising a plurality of video frames. Further embodiments relate to a computer program for implementing said method and a computer readable non-transitory medium storing such a computer program.

### BACKGROUND OF THE INVENTION

Digital still image and video signals exhibit different types of artefacts generated through signal processing techniques applied to a digital image signal, like filtering, transformations between time domain and frequency domain, and compression/decompression. One type of artefacts is ringing on at least one side of an edge appearing in the imaged scene. Ringing, also called mosquito noise, results from band limitations in the preceding signal processing. Ringing appears both in still images and video streams containing a plurality of video frames. Another type of artefacts is blocking which appears as a mosaicization of the image. Blocking may result from block-based compression schemes like JPEG, MPEG1, MPEG2, MPEG4 and others.

Conventional techniques for reducing these artefacts work either in a coded domain or in a baseband domain. De-blocking and de-ringing schemes working in the coded domain require access to the encoder information, which is not always available at the decoder side. Instead, baseband approaches do not necessarily require encoder information but tend to reduce, together with the blocking and ringing artefacts, also the texture and sharpness of the images in the vicinity of the reduced artefacts.

A usual approach for reducing ringing and blocking artefacts is to identify block boundaries and image edges and to low-pass the picture orthogonal to the detected boundaries or edges. Such process low-passes the area in the vicinity of the edges and block boundaries. Texture in this area is smoothed, causing unwanted secondary artefacts appearing as blurring.

### SUMMARY OF INVENTION

It is an object of the present invention to provide an image processing apparatus and a corresponding method for reducing edge-induced artefacts in an image signal descriptive for a still image or a video, while keeping adverse effects on image/video quality low, for example by avoiding a texture in the vicinity of edges to be blurred. It is a further object of the present invention to provide a computer program and a computer readable non-transitory medium for implementing said method. The object is achieved by the subject-matter of the independent claims. The dependent claims define further embodiments.

Details and advantages of the invention will become more apparent from the following description of embodiments in connections with the accompanying drawings. Features of the various embodiments may be combined unless they exclude each other.

### BRIEF DESCRIPTION OF THE DRAWINGS

FIG. 1A is a schematic block diagram of an electronic device with an image processing apparatus for reducing edge-induced artefacts in accordance with an embodiment of the invention.

FIG. 1B is a schematic block diagram showing details of the image processing apparatus of FIG. 1A.

FIG. 1C shows details of a wavelet decomposition unit of the image processing unit of FIG. 1B in accordance with an embodiment referring to discrete wavelet transformation.

FIG. 1D is a schematic block diagram of a wavelet decomposition unit of the image signal processing unit of FIG. 1B in accordance with an embodiment referring to wavelet package decomposition.

FIG. 1E illustrates effects of the wavelet decomposition unit of FIG. 1D.

FIG. 1F shows diagrams illustrating the effects of contour lines, block boundaries and texture on detail and approximation signals for discussing effects underlying the present invention.

FIG. 1G is a schematic block diagram showing details of a wavelet composition unit of the image processing unit of FIG. 1B in accordance with an embodiment referring to wavelet package decomposition.

FIG. 2A is a schematic block diagram of an image processing unit in accordance with an embodiment related to de-blocking.

FIG. 2B is a picture including diagonal details of a test image for discussing effects underlying the present invention.

FIG. 2C is a picture illustrating vertical details of the test image for discussing effects underlying the present invention.

FIG. 2D is a picture showing horizontal details of the test image for discussing effects underlying the present invention.

FIG. 3A is a block diagram showing details of a block detection unit of the image processing unit of FIG. 2.

FIG. 3B is a diagram illustrating a filter for detecting block corners in accordance with an embodiment of the invention.

FIG. 3C is a 3-D plot of the filter of FIG. 3B.

FIG. 3D is a diagram illustrating a filter for detecting vertical block boundaries in accordance with an embodiment.

FIG. 3E is a 3D-plot of the filter of FIG. 3D.

FIG. 3F is a diagram illustrating a filter for detecting horizontal block boundaries in accordance with an embodiment.

FIG. 3G is a 3D-plot of the filter of FIG. 3F.

FIG. 4A is a schematic diagram illustrating moving blocks for discussing effects underlying the present invention.

FIG. 4B shows diagrams with vertical, horizontal details for discussing effects of embodiments related to the detection of moving blocks.

FIG. 4C is a schematic diagram for defining a filter for detecting moving vertical block boundaries.

FIG. 4D is a schematic diagram for defining a filter for detecting moving horizontal block boundaries.

FIG. 5A is a schematic diagram illustrating an image section with a horizontal and a vertical block boundary.

FIG. 5B is a schematic diagram illustrating artefact reduction by equalizing in accordance with an embodiment related to horizontal block boundaries.

FIG. 5C is a schematic diagram illustrating artefact reduction by equalizing in accordance with an embodiment related to vertical block boundaries.

FIG. 5D is a schematic diagram illustrating artefact reduction by equalizing in accordance with an embodiment related to boundary crossings.

FIG. 6A is an exemplary picture with vertical block boundaries for illustrating effects of an embodiment.

FIG. 6B is a picture derived from the picture of FIG. 6A using de-blocking in accordance with an embodiment related to vertical block boundaries.

FIG. 6C is an exemplary picture with horizontal block boundaries for illustrating effects of an embodiment.

FIG. 6D is a picture derived from the picture of FIG. 6A using de-blocking in accordance with an embodiment related to horizontal block boundaries.

FIG. 6E is an exemplary picture with boundary crossings for illustrating effects of an embodiment.

FIG. 6F is a picture derived from the picture of FIG. 6A using de-blocking in accordance with an embodiment related to boundary crossings.

FIG. 7A is a diagram showing a row of pixels for discussing the effect of energy equalization in accordance with an embodiment.

FIG. 7B is a diagram showing a row of pixels for discussing the effect of energy equalization in accordance with a further embodiment.

FIG. 8A is a schematic block diagram of an image processing unit in accordance with an embodiment related to de-ringing.

FIG. 8B is a schematic block diagram of an image processing unit in accordance with an embodiment combining de-ringing and de-blocking.

FIG. 9A is a schematic block diagram illustrating details of an edge detection unit of the image processing units of FIGS. 8A and 8B in accordance with an embodiment.

FIG. 9B is a schematic block diagram illustrating details of a threshold unit of the edge detection unit of FIG. 9A.

FIGS. 10A to 10F are exemplary pictures illustrating the mode of operation of the edge detection unit of FIG. 9A.

FIGS. 11A and 11B illustrate the mode of operation of the threshold unit of FIG. 9B.

FIGS. 12A and 12B are pictures illustrating the effect of a hysteresis unit of the edge detection unit of FIG. 9A.

FIGS. 13A and 13B are pictures illustrating the effect of an embodiment related to de-ringing applied to not-deblocked signals.

FIGS. 14A and 14B are pictures illustrating the effect of an embodiment related to de-ringing performed after de-blocking.

FIG. 15 is a schematic diagram showing sub-areas along an edge for discussing effects underlying the invention.

FIGS. 16A and 16B are schematic diagrams illustrating the mode of operation of a de-ringing unit in accordance with an embodiment not considering previous equalizations.

FIGS. 17A and 17B are schematic diagrams illustrating the mode of operation of a de-ringing unit in accordance with an embodiment considering previous equalization steps.

FIGS. 18A and 188 show horizontal details of a section of an exemplary picture before and after performing de-ringing.

FIGS. 19A and 19B show the section of the exemplary picture of FIGS. 18A and 18B before and after performing de-ringing.

FIG. 20A is a diagram showing sub-band edge peeking for discussing effects of the sharpness enhancement.

FIG. 20B is a diagram showing sub-band edge peeking for first vertical details.

FIG. 20C is a diagram illustrating sub-band edge peeking for second vertical details.

FIG. 21 is a simplified flowchart of a method of operating a image processing unit in accordance with a further embodiment.

### DESCRIPTION OF PREFERRED EMBODIMENTS

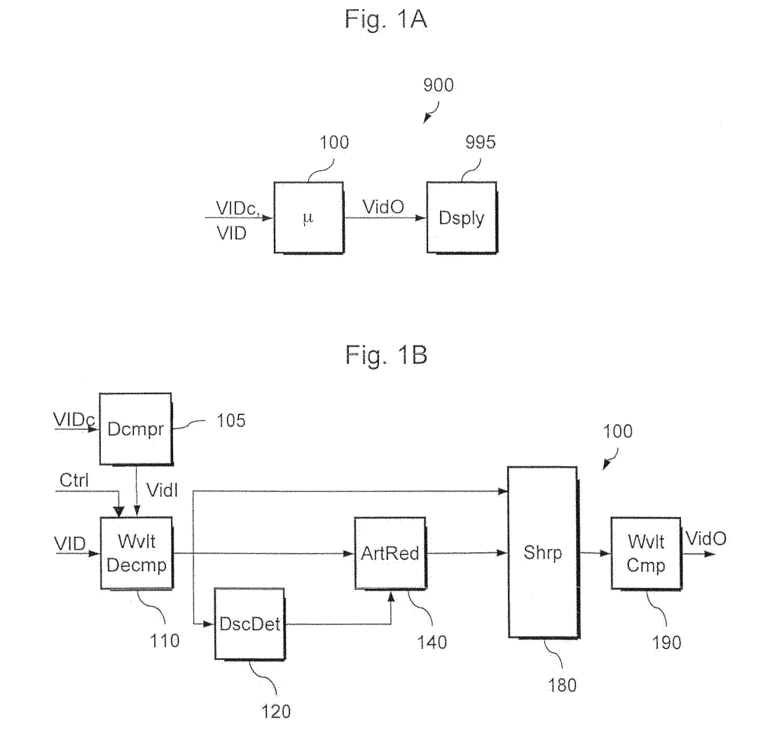

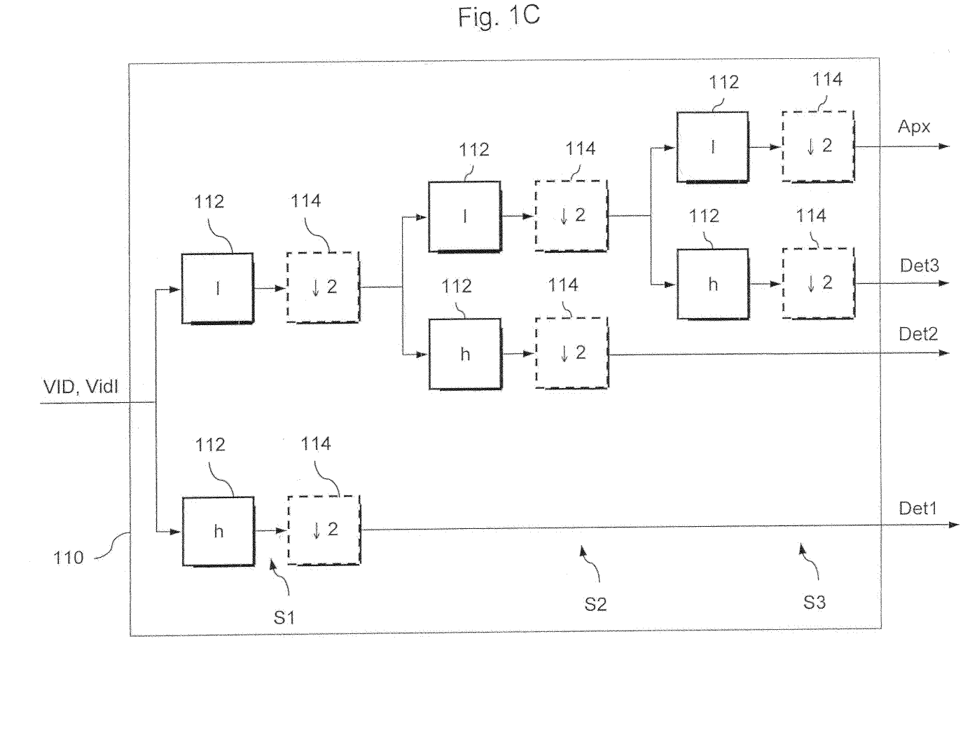

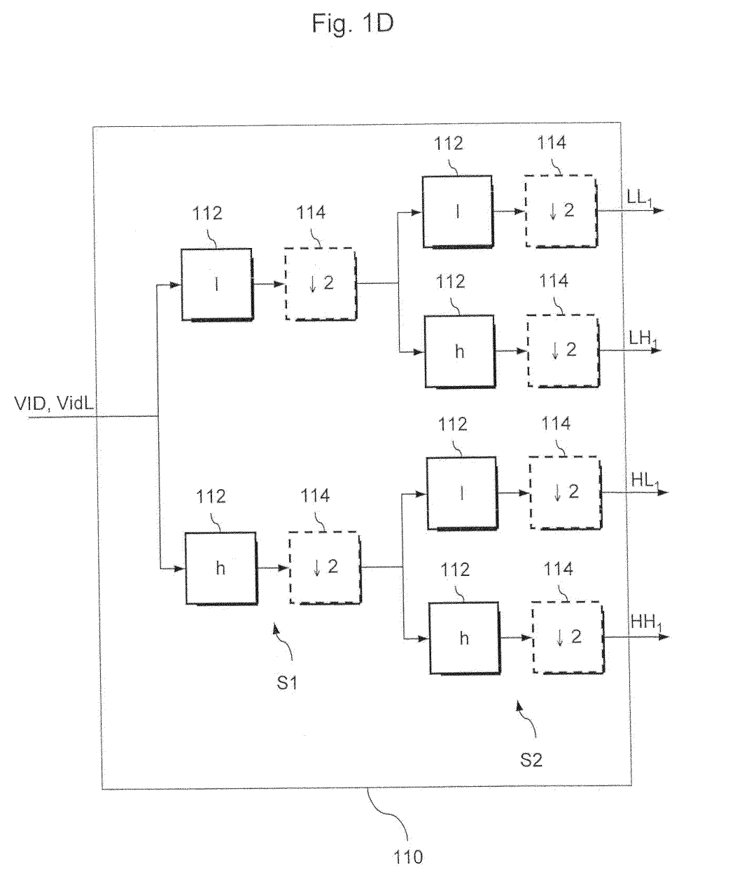

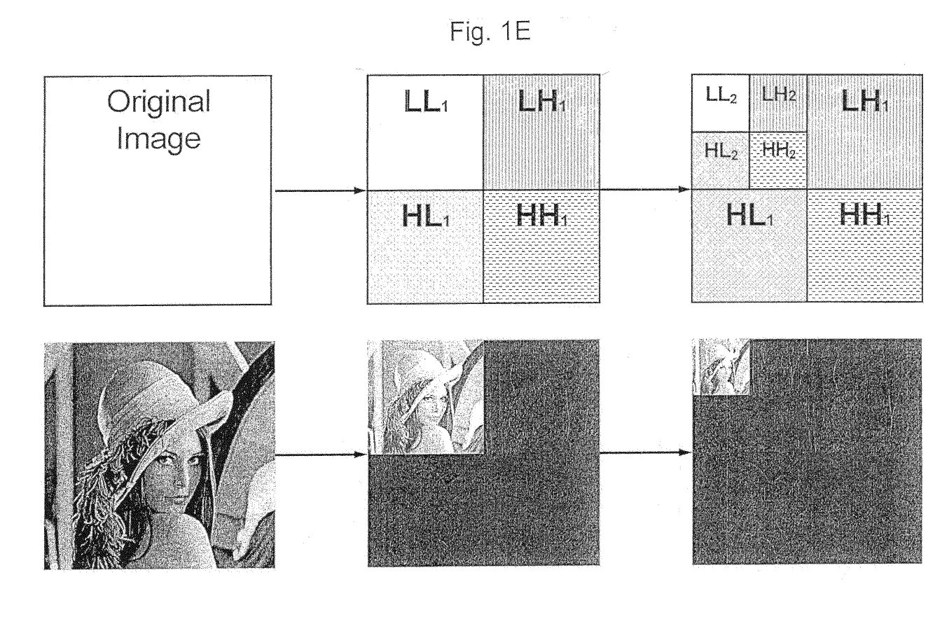

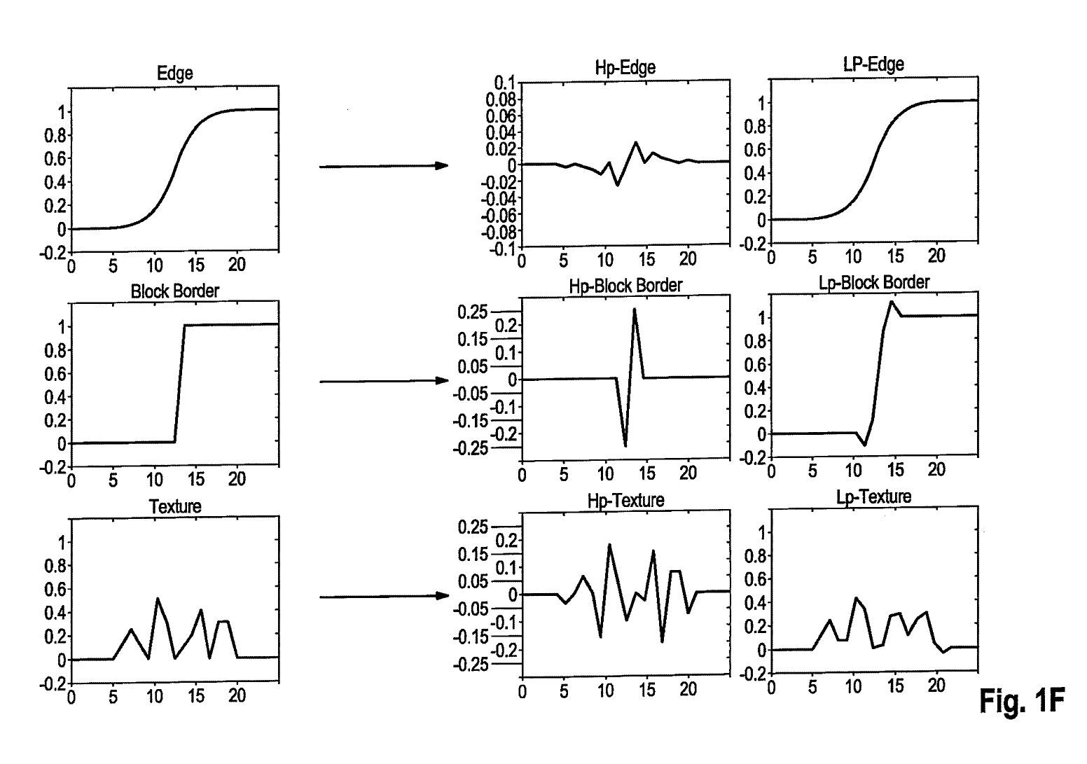

FIG. 1 shows an electronic device 900 for processing compressed source image data VIDc and/or not-compressed source image data VID received from an image data source. The electronic device 900 may be a device intended for stationary use like a television apparatus or a computer. According to another embodiment, the electronic device 900 is a portable device like a cellular phone, an e-book, a tablet device, a personal digital assistant or a smart phone. The image data source may be a camera unit, a broadcast receiver unit or a storage unit. The image data source may be an integral part of the electronic device 900 or, according to another embodiment, an integral part of another electronic device connected to the electronic device 900 through a wired connection line or wirelessly.

The compressed source image data VIDc may represent compressed image data descriptive for a still image or a video stream containing a plurality of video frames. The compressed source image data VIDc may result from applying a compression scheme like JPEG (joint photographic experts group), or MPEG (moving picture experts group) to raw image/video data. According to other embodiments, not-compressed source image data VID is supplied to the electronic device 900.

The electronic device 900 includes an image processing unit 100 that may apply a suitable decompression scheme on the compressed source image data VIDc to provide a decompressed input data signal VidI. The image processing unit 100 reduces edge-induced artefacts in the decompressed input data signal VidI or the not-compressed source image data VID. In the following, the term “input data signal” is intended for including both the not-compressed source image data VID and the decompressed input data VidI. The image processing unit 100 performs a wavelet decomposition for obtaining at least one detail signal and at least one approximation signal, each detail and approximation signal describing the input data signal in another frequency range. In accordance with the common terminology in the pertinent art, each “detail signal” or high-frequency “band” is described by the respective detail components and each “approximation signal” or low-frequency “band” is given by the respective approximation coefficients.

The image processing unit 100 applies a discontinuity detection scheme on one or more of the detail and approximation signals to identify discontinuities and areas prone to edge-induced artefacts. The discontinuities can be edges in the imaged scene, for example object contour lines or boundaries of pixel blocks, wherein pixel values of pixels assigned to the same pixel block result from the same block operation during a preceding non-ideal, block-oriented transformation or motion estimation processing which may be, for example, part of a compression/decompression procedure. The artefact-prone areas may be areas directly adjoining to contour lines in the image content and/or areas directly adjoining to block boundaries. In the identified artefact-prone areas the image processing unit 100 applies an artefact reduction scheme to one or more of the detail and approximation signals originating from the wavelet transformation.

For example, the image processing unit 100 applies a de-ringing scheme for reducing ringing artefacts and/or a de-blocking scheme for reducing blocking artefacts. The artefact reduction scheme may be based on an approach equalizing energy or pixel values in artefact-prone areas adjoining to the detected edge/boundary with the energy or pixel values of reference areas on one or both sides of the edge/boundary in a greater distance to the edge/boundary. The distance between the edge/boundary and the reference area may be greater than one, two or three pixels. The distance may be less than 2 times a block-size, for example 16 or 8 pixels. According to an embodiment, the equalization may be performed in a way that a pattern in the reference area is projected into the artefact-prone area. The artefact reduction scheme may be applied to all or some of the detail and approximation signals or frequency bands. According to an embodiment, the equalization is applied to one or more of the detail signals exclusively. According to another embodiment the image processing unit 100 applies the artefact reduction scheme exclusively to those signal bands that have been used for detecting the respective artefact-prone areas.

The image processing unit 100 further applies a wavelet composition scheme to combine the corrected detail and approximation signals and other detail and approximation signals, which have not been subjected to an artefact reduction scheme, in order to generate an output data signal VidO. The image processing unit 100 may supply the output data signal VidO to an output unit 995. The output unit 995 may be a display for displaying an image or movie on the basis of the output data signal VidO, a storage unit for storing the output data signal VidO, or a data interface unit for transmitting the output data signal VidO to another electronic device.

FIG. 1B shows details of an embodiment of the image processing unit 100 of FIG. 1A. A decompression unit 105 applies a suitable decompression scheme to decompress the received compressed source image data VIDc and outputs a decompressed input data signal VidI. A wavelet decomposition unit 110 performs 1D, 2D or 3D wavelet decomposition to decompose the input data signal, which may be the decompressed input data signal VidI or the not-compressed source image data VID, into at least one detail signal and at least one approximation signal. By way of example, the wavelet decomposition unit 110 applies a high-pass filter on the input data signal to generate the detail signal and a low-pass filter for producing the approximation signal. The wavelet decomposition unit 110 may comprise one filter stage with one high-pass filter and one low-pass filter or a plurality of filter stages, wherein each filter stage includes a high-pass filter and low-pass filter to obtain a further approximation signal and a further detail signal by applying the filters on one of the output signals of the previous signal stage.

At least one of the detail and approximation signals is supplied to a discontinuity detector unit 120. The discontinuity detector unit 120 may scan one or more of the detail and approximation signals for block boundaries and/or may scan one or more of the detail and approximation signals for edges in the imaged scene, for example objects contour lines. An artefact reduction unit 140 applies a discontinuity-type specific artefact reduction scheme on at least one of the detail and approximation signals, for example on those ones used for the detection of the respective possible artefact area. According to an embodiment, the image processing unit 100 may further include a sharpness enhancement unit 180 enhancing sharpness information in at least one of the detail and approximation signals. A wavelet composition unit 190 applies a wavelet composition scheme to combine those detail and approximation signals subjected to an artefact reduction scheme and those detail and approximation signals, which have not been subjected to an artefact reduction scheme, to generate a corrected output data signal VidO.

FIGS. 1C and 1D show details of an embodiment of the wavelet decomposition unit 110 of FIG. 1B. Wavelet decomposition is used to divide a given continuous-time signal into different scale components, wherein each scale component is assigned to a frequency range (frequency band). Each scale component can then be studied with a resolution that matches its scale. A wavelet transform is the representation of a signal by wavelets. The wavelets are scaled and translated copies known as “daughter wavelets” of a finite-length or fast-decaying oscillating waveform known as “mother wavelet”. Wavelet transforms have advantages over traditional Fourier transforms for representing functions that have discontinuities and sharp peaks, and for accurately deconstructing and reconstructing finite, non-periodic and/or non-stationary signals. The wavelet decompression unit 110 may perform a continuous wavelet transform (CWT), a discrete wavelet transformation (DWT) or a wavelet package decomposition (WPD).

According to the embodiment of FIG. 1C, the wavelet decomposition unit 110 performs a DWT and may include a number of filter units 112 arranged in pairs, wherein each filter pair is assigned to a filter stage S1, S2, Sn with n=1, 2, . . . , . One of the filter units 112 of each filter pair is a low-pass filter with the impulse response 1 and the other filter unit 112 of the same filter pair is a high-pass filter with the impulse response h, wherein the frequency ranges of each filter pair complement each other. The input signal of the filter pair of the first stage S1 is the input data signal of the wavelet decomposition unit 110. Both filter units 112 of each filter pair of the stage S2, S3, . . . (n=2) receive the approximation signal output by the low-pass filter unit 112 of the preceding stage Sn. The filter units 112 of each filter pair may be quadrature mirror filters with frequency characteristics symmetric about ¼ of the respective sampling frequency, i.e. /2. The decomposition can be repeated one or more times to further increase the frequency resolution of the approximation coefficients.

The wavelet decomposition unit 110 performs the DWT of the data input signal VidI by passing it through the filter units 112. The output signal of a low-pass filter unit 112 with impulse response 1 results from a convolution of the data input signal with the impulse response 1 and gives the approximation signal of the respective filter stage. The output signal of a high-pass filter unit 112 with impulse response h results from a convolution of the data input signal with the impulse response h and represents the detail signal of the respective filter stage.

According to an embodiment, down-sampling units 114 are provided to discard half the samples of the respective output signals of the filter units 112. Each output signal of a filter unit 112 has half the frequency range of the respective input signal, i.e. the frequency resolution has been doubled. Like typical wavelet transformation applications this embodiment provides sub-sampling of the output signals of the filter units 112 by discarding each second sample value to exploit that sub-sampling is invariant in case of linear operations.

According to another embodiment, however, the wavelet decomposition unit 110 does not provide sub-sampling to support a non-linear processing. By abandoning the sub-sampling no information is lost. Furthermore, abandoning the sub-sampling allows exploiting a local correlation of the input data signal. Finally, sub-sampling a band would remove the phase information, which is useful in case of moving sequences.

FIG. 1D refers to an embodiment of the wavelet decomposition unit 110 performing a wavelet packet decomposition (WPD). The input data signal is passed through more filters than in the discrete wavelet transform. While in the DWT each level is calculated by passing only the previous approximation coefficient, i.e. the output of the low pass filter path, through low and high pass filters, with the WPD, both the detail component and the approximation coefficient, i.e. the outputs of both the low-pass and the high-pass filter units 112 are further decomposed, to achieve, e.g., four levels of decomposition or more. For n-levels, the WPD produces 2ⁿ different sets of coefficients (or nodes), with n=1, 2, . . . . Again, some embodiments may provide sub-sampling units 114, whereas others do not.

FIG. 1E refers to an embodiment of the wavelet decomposition unit 110 providing a two-level, two-dimensional wavelet packet decomposition (WPD). Four signals (“channels”) obtained by the first two stages of the WPD are indicated by HH₁, HL₁, LH₁ and LL₁. The letter H indicates the output of a high-pass filter and the letter L indicates the output of a low-pass filter of the first stage. L₁, H₁ indicate filter outputs of the second stage. In general the signal LL shows the approximation, the signal LH shows horizontal details, the signal HL shows vertical details and the signal HH shows diagonal details. Each stage may be assigned to a picture dimension, i.e. the first stage to the vertical and the second stage to the horizontal picture dimension.

FIG. 1E shows an example of the application of a two-dimensional wavelet decomposition on an original image resulting in four signals LL₁, LH₁, HL₁, HH₁ after a second stage, wherein a third stage decompresses the LL₁ frequency band of the second stage into four further signals LL₂, LH₂, HL₂, HH₂.

According to the present invention the wavelet decomposition unit 110 is generally adapted for applying a 2D wavelet decomposition by which the input data signal descriptive for a still image or video frame is decomposed into four detail and approximation signals. Instead of applying a 2D wavelet decomposition two times a 1D wavelet decomposition can be applied as well, wherein in each stage a decomposition in two frequency bands is performed. Other embodiments provide a 3D wavelet decomposition.

According to an embodiment, the wavelet decomposition is iteratively applied, e.g. the input video frame of the input video is iteratively decomposed by use of a plurality of stages (cascades) of at least two wavelet decompositions in a plurality of frequency bands of at least two stages. At least the lowest frequency band of a particular level is decomposed into at least two frequency bands of the subsequent level. According to the embodiment shown in FIG. 1E the LL₁ frequency band may be decomposed into frequency bands LL₂, LH₂, HL₂, HH₂ of the subsequent level. The wavelet decomposition unit 110 may be configurable via a control signal Ctrl. For example, a user may select the number of decompositions and filter stages, for instance, dependent on a desired level of accuracy of a block artefact reduction.

The wavelet decomposition unit 110 may apply one of several types of wavelets. For example, the wavelet decomposition unit 110 may be configurable to apply one of Le Gall 5/3 and Daubechies 9/7 wavelets. According to an embodiment, the length of the wavelet is, at least for the high-pass part, shorter than a corresponding block dimension used in a selected compression/decompression scheme. For example, the wavelet has less than 8 taps in order to avoid crossing more than one block boundary in images compressed according to JPEG, MPEG1, MPEG2 or MPEG4 schemes. According to an embodiment, each dimension of the filter functions performed by the respective filter unit is selected to be smaller than the corresponding block dimension. The block dimensions may be given by the block size used in a previous processing stage, for example in a compression/decompression stage. For many compression/decompression schemes the block size is 8×8 pixels. According to an embodiment, the filter units 112 of the wavelet decomposition unit 110 may be configurable such that they can be adapted/selected to different block sizes.

FIG. 1F illustrates diagrams referring to picture features and their representations in detail and approximation signals. The top row refers to a typical object-contour edge in an imaged scene, the row in the middle to a block boundary and the bottom row to a textured area. The left-hand column shows the spatial gradient of energy or luminescence in the picture in the vicinity of the respective picture feature. The column in the middle shows the gradients of a high-pass channel (detail signal), and the right-hand column the gradients of the respective low-pass channel (approximation signal) derived from a respective input data signal according to the left-hand column.

With regard to a block boundary (row in the middle) the idea is to exploit the correlation between a boundary and what there is in the image frame. In particular, it has been recognized that it is possible to equalize the activity in the wavelet domain instead of using low-pass filters in it or even in the original image. Known de-blocking algorithms are just block boundary adapters, in other words they change the type of filtering with a size of the block boundary. They do not work well in texture areas because they low-pass too much of the texture or they leave the artefact. Instead, the present embodiments are adaptive at the same time on the block boundary and the surrounding areas exploiting that there is more activity intrinsic in/at the block boundary in the wavelet domain compared to texture areas. After the wavelet decomposition, block detection may be performed using at least one evaluation signal, for example in at least one high frequency channel of at least two frequency channels obtained by the wavelet decomposition. The block boundaries may be identified exploiting block grid regularities and correlation between the block boundaries. According to an embodiment, knowledge about how a block boundary is represented in the wavelet domain is exploited to detect the block boundaries.

With regard to image edges like contour lines in the imaged scene (top row) the idea is to distinguish them from the block boundaries and to handle them differently. The edge processing may be based on an equalization scheme between neighbouring blocks at the same side of a detected edge, whereas the block boundary processing involves equalization with regard to both sides of the block boundary.

Using wavelets as proposed according to the present invention allows to easily performing, at the same time, other tasks in the wavelet domain, like noise reduction and sharpness enhancement. A sharpness enhancement unit 180 performs sharpness enhancement of the image after de-blocking and before wavelet composition. Instead or in addition to the sharpness enhancement unit 180 other image processing means for image processing of the processed frequency bands and/or the input video frame in the wavelet domain may be provided in other embodiments, in particular for noise reduction, colour saturation enhancement, hue enhancement, brightness enhancement and/or contrast enhancement, before wavelet composition.

FIG. 1G shows details of an embodiment of the wavelet composition unit 190 of FIG. 1B. The wavelet composition unit 190 includes inverse filter units 192 that inverse-filter the frequency bands and summation units 195 that superpose the outputs of the inverse filter units 192 to perform an inverse wavelet transform. The wavelet composition is complementary to the wavelet decomposition of the wavelet decomposition unit 110 and outputs an image output signal VidO. Depending on whether or not down-sampling has been performed, the wavelet composition unit 190 may include up-sampling units 194 to compensate for a down-sampling at the decomposition side. The wavelet composition unit 190 subjects both the de-blocked and further, non-processed detail and approximation signals or frequency bands to the inverse wavelet transform.

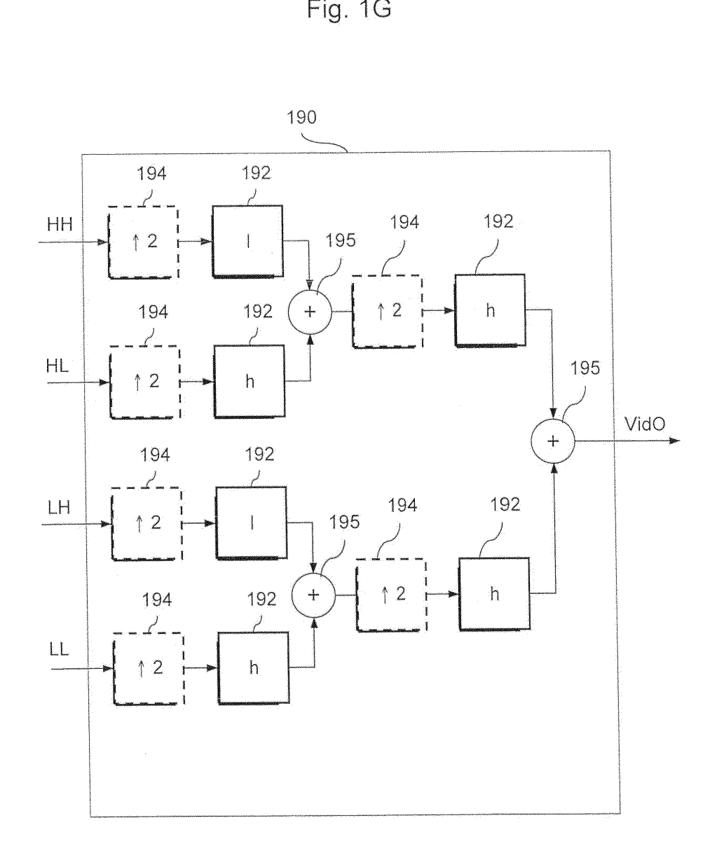

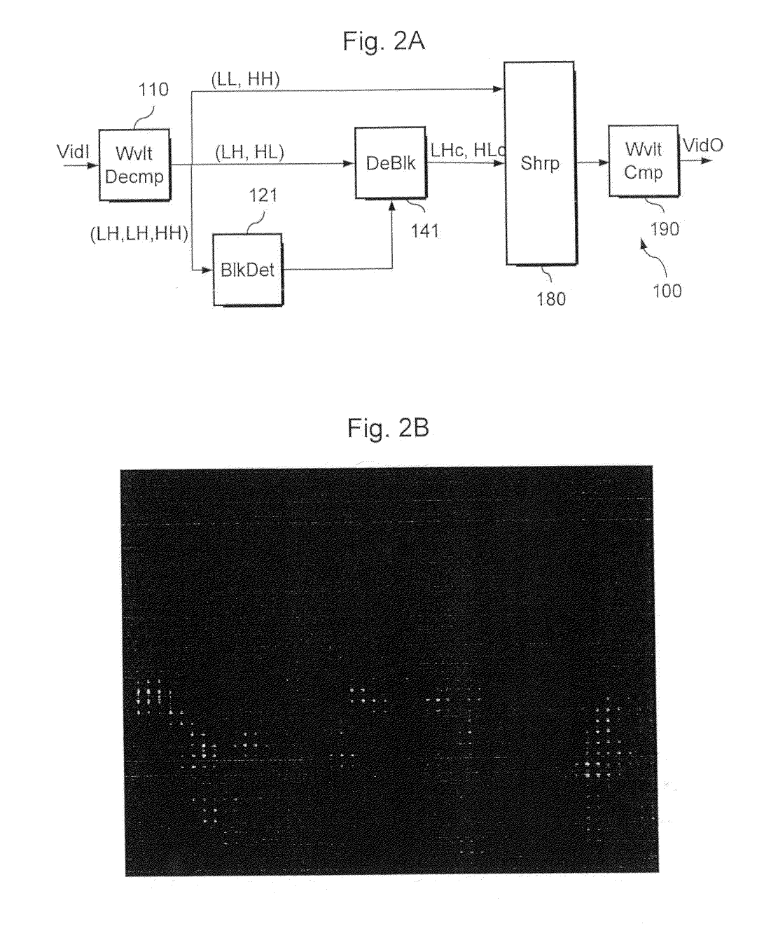

FIG. 2A shows an embodiment of the image processing unit of FIG. 1B related to the reduction of discontinuity-induced artefacts occurring in the vicinity of block boundaries. A block detection unit 121 evaluates one or more of the detail and approximation signals (frequency bands) output by the wavelet decomposition unit 110 as evaluation signals. According to an embodiment, the block detection unit 121 evaluates a first stage high-frequency band (detail signal) or a sub-band derived from the first order high-frequency band and outputs block position information describing the identified block boundaries. A de-blocking unit 141 receives the block position information and at least some of the signals output by the wavelet decomposition unit 110, for example at least that signal or those signals from which the position information has been derived. The de-blocking unit 141 performs an equalization process equalizing the energy at the identified boundaries with that of reference pixels assigned to the neighbouring blocks. According to an embodiment, the neighbouring pixels and blocks are those ones directly adjoining to the identified block boundary. According to other embodiments further pixels and blocks not directly adjoining to the block boundary but adjoining to the blocks directly adjoining to the block boundary may be considered.

According to an embodiment the block detection unit 121 estimates the block position information on the basis of the detail signal obtained by the first wavelet iteration that already provides a lot of information on the position of the blocks as shown in FIGS. 2B, 2C, 2D.

FIG. 2B visualizes diagonal details of a block grid of a test image, FIG. 2C refers to vertical details of a block grid are shown in FIG. 2C, and FIG. 2D to horizontal details of a block grid. The images of FIGS. 2B, 2C and 2D result from a convolution of the original test image with Le Gall 5/3 filters, which are smaller than typical blocks.

Each detail signal has its own characteristics and so different procedures may be applied. Moreover, the amount of correlation can also intrinsically provide a level of blockiness. It is then possible to use this information to apply a smoother or a stronger de-blocking algorithm that, in the wavelet domain, leads to iterate the wavelet decomposition more or less often.

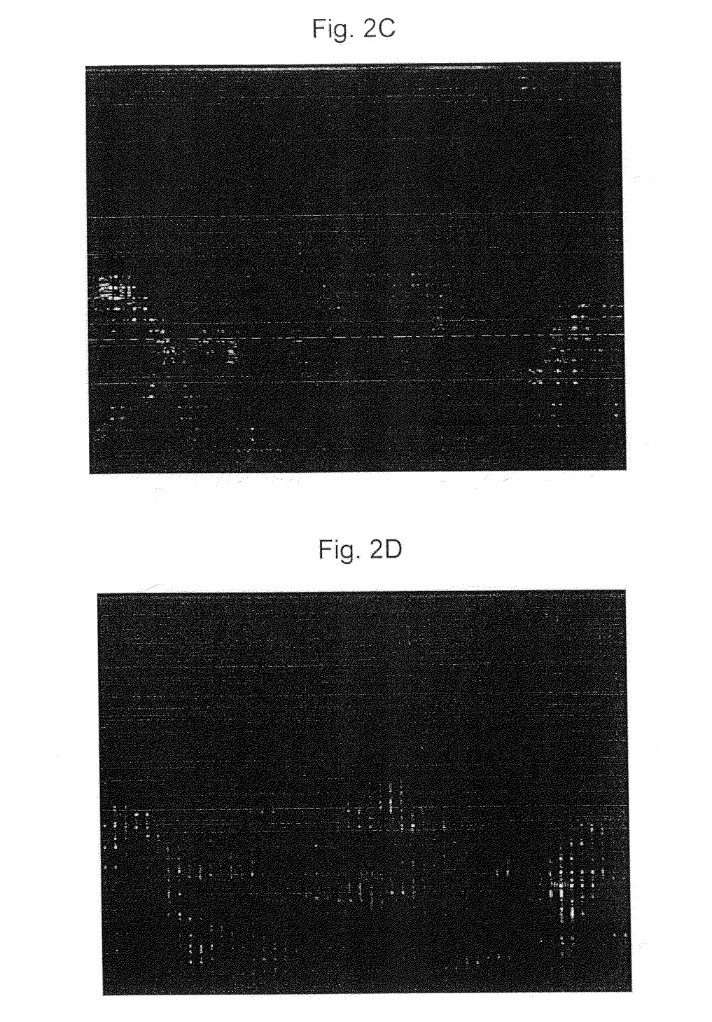

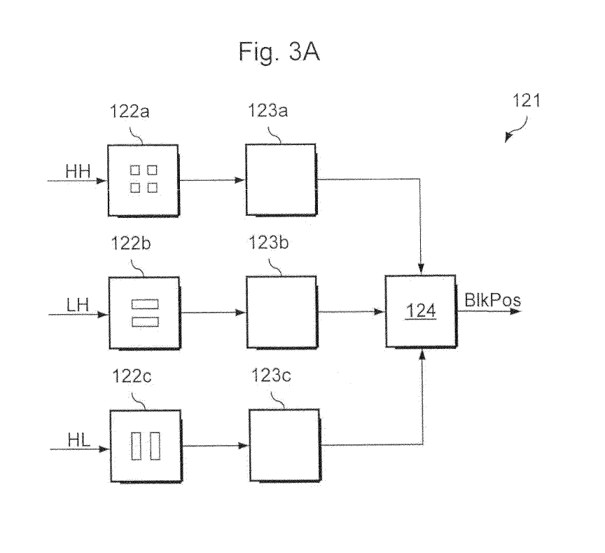

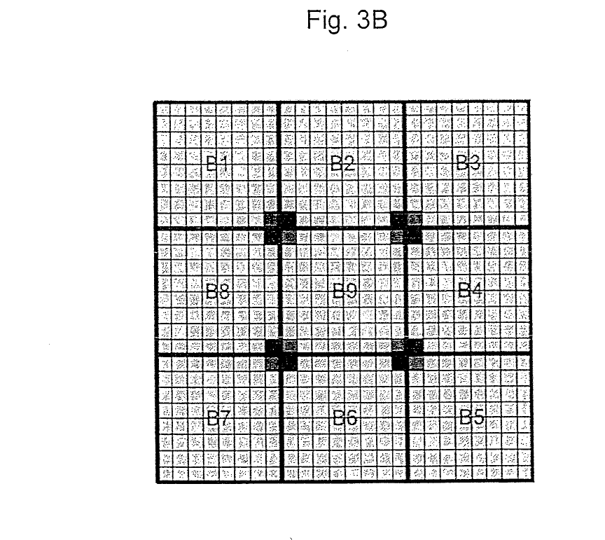

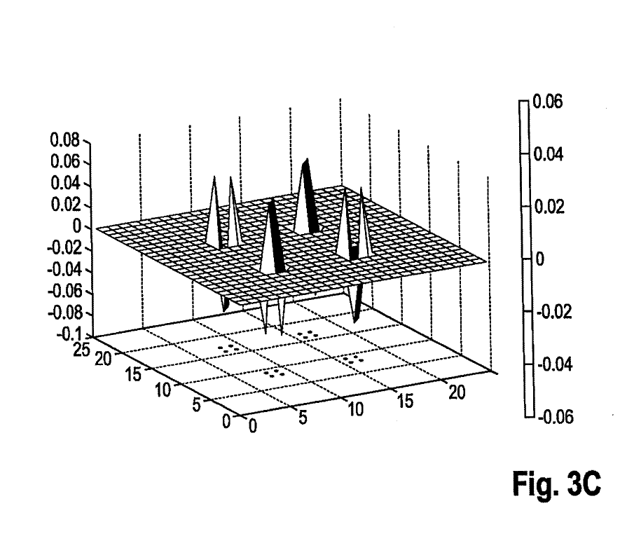

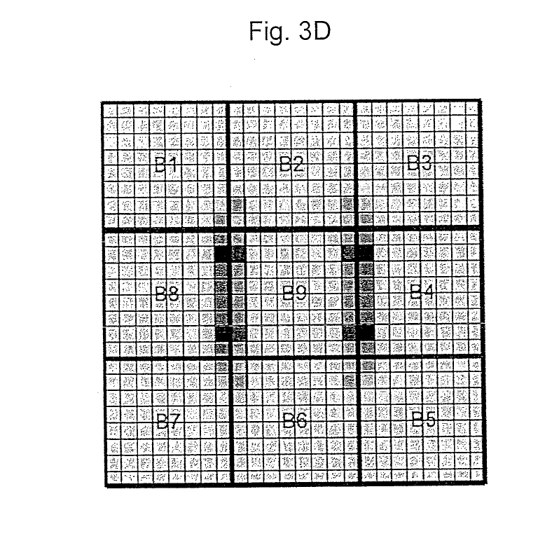

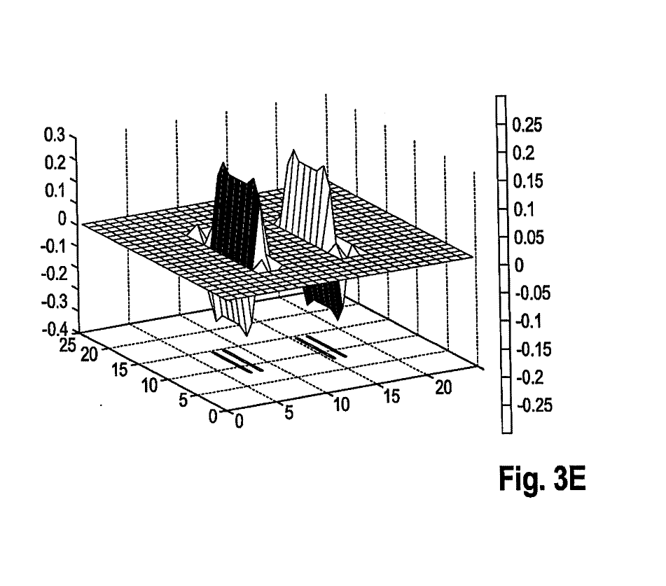

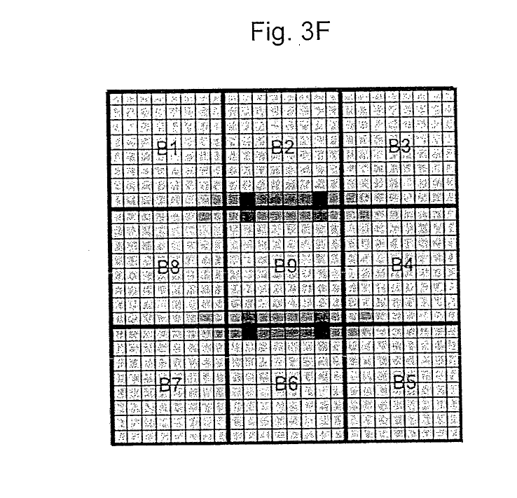

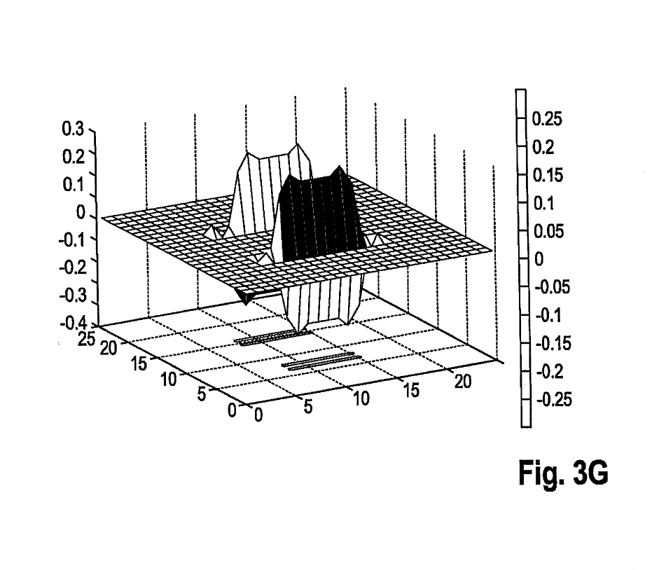

FIG. 3A shows details of the block detection unit 121 of FIG. 2A and FIGS. 3B to 3G illustrate its mode of operation. A filtering, which is effective on both the pixel rows and pixel columns using a high-pass filter may be applied to produce a signal descriptive for diagonal details. In the presence of a block, the diagonal details usually show the four block corners of a perfect block. This spatial pattern is not so common in a typical image scene. Also, there should be also some activity within the block. However, the energy at the block corners is greater than the one inside and presents a particular pattern. Hence, according to an embodiment the block detection unit 121 of FIG. 2A may exploit the correlation of a detail signal with the block corners of a perfect block. A first weighting unit 122a may weight four pixel groups located at the corners of an 8×8 grid to emphasize an edge quality in the underlying HH detail signal. According to an embodiment, the pixels of each pixel group are arranged to form a square. Each pixel group may include four pixels or more, e.g. nine pixels. The values of diagonal pixels in each square may be summed up and a difference of both diagonal sums may be calculated for each pixel group. The absolute values of the four diagonal differences may be summed up. Applied to an approximation or detail signal, the resulting value (Block Corner) is high where four edges are arranged in a 8×8 grid. For example, the value “Block Corner” may be calculated using the following equations, with HH(n, m) referring to the detailed diagonal detail signal obtained by the wavelet decomposition unit 110:

A=HH(x−4,y−4)−HH(x−3,y−4)+HH(x−3,y−3)−HH(x−4,y−3)

B=HH(x−4,y+4)−HH(x−3,y+4)+HH(x−3,y+5)−HH(x−4,y+5)

C=HH(x+4,y−4)−HH(x+5,y−4)+HH(x+5,y−3)−HH(x+4,y−3)

D=HH(x+4,y+4)−HH(x+5,y+4)+HH(x+5,y+5)−HH(x+4,y+5)

BlockCorner(x,y)=|A|+|B|+|C|+|D|

In the presence of a block, the first weighting unit 122a produces an output signal in which block corners are extremely visible even in textured areas. After that, in order to find the most probably position of the blocks, for every 8×8 area a first search unit 123a searches for the maximum activity and stores the respective row and column offsets. With the knowledge of the offsets for every 8×8 area of the image, it is then possible to define the more common row offset (DROffset), column offset (DCOffset) and their reliability (DRCOffset % and DCOffset %) as the overall ratio.

The vertical coefficients may result from a row convolution with a high-pass filter and a column convolution with a low-pass filter. For this reason the prevalent directions are vertical and so it is appropriate to detect the vertical block boundaries. For example, a second weighting unit 122b may perform a line-highlighting filtering and may use the following equations to calculate a correlation with the perfect block boundary as shown in FIGS. 3D, 3E.

A=−HL(x,y−4)+HL(x,y−3)

B=HL(x,y+4)−HL(x,y+5)

VerticalBlockBorder(x,y)=|A|+|B|.

This iteration provides the FIG. 3D and from this the calculation of the maximum activity in every 1×8 area in a second search unit 123b may calculate the most common column offset (VCOffset) and its reliability (VCOffset %).

The horizontal coefficients are exactly the orthogonal version of the vertical coefficients. In fact the low-pass filtering is on the rows and the high-pass filtering is applied to the columns. This filtering points out the horizontal structures like horizontal block boundaries. The amount of correlation as calculated by the following equations

A=−LH(x−4,y)+LH(x−3,y)

B=LH(x+4,y)−LH(x+5,y)

HorizontalBlockBorder(x,y)=|A|+|B|

A third weighting unit 122c and a third search unit 123c may calculate the maximum activity in every 8×1 area that gives the most common row offset (HROffset) and its reliability (HROffset %). The correlation with the perfect block boundary is shown in FIGS. 3F, 3G.

At this point, having the blocking knowledge of the detail coefficients of the first wavelet iteration, the previous results may be merged in one that points out the amount of blockiness in the image. For example, a merging unit 124 may evaluate the following relations to provide a reliable result:

BlockLevel=2 if DROffset=HROffset with DROffset %,HROffset %>75%̂DCOffset=VCOffset with DCOffset %,VCOffset %>75%

BlockLevel=1 if DROffset=HROffset with DROffset %,HROffset %>50%̂DCOffset=VCOffset with DCOffset,VCOffset %>50%

BlockLevel=0 otherwise

According to another embodiment, the block boundaries may be detected in the low frequency band. However, since block boundaries have high frequency content and since in the low frequency band picture information merges with block boundary information, they are typically more easily detectable in high frequency bands. According to another embodiment, the block detection unit 121 uses both high and low frequency bands.

Another embodiment of the block detector unit 121 applies a dynamic block grid detection process to allow handling of macro-block concepts on the compression side. In some compressed video streams, for example in MPEG-1/2/4 coded video streams, blocking artifacts are carried over from frame to frame in a fashion that they are not aligned to the 8×8 coding block.

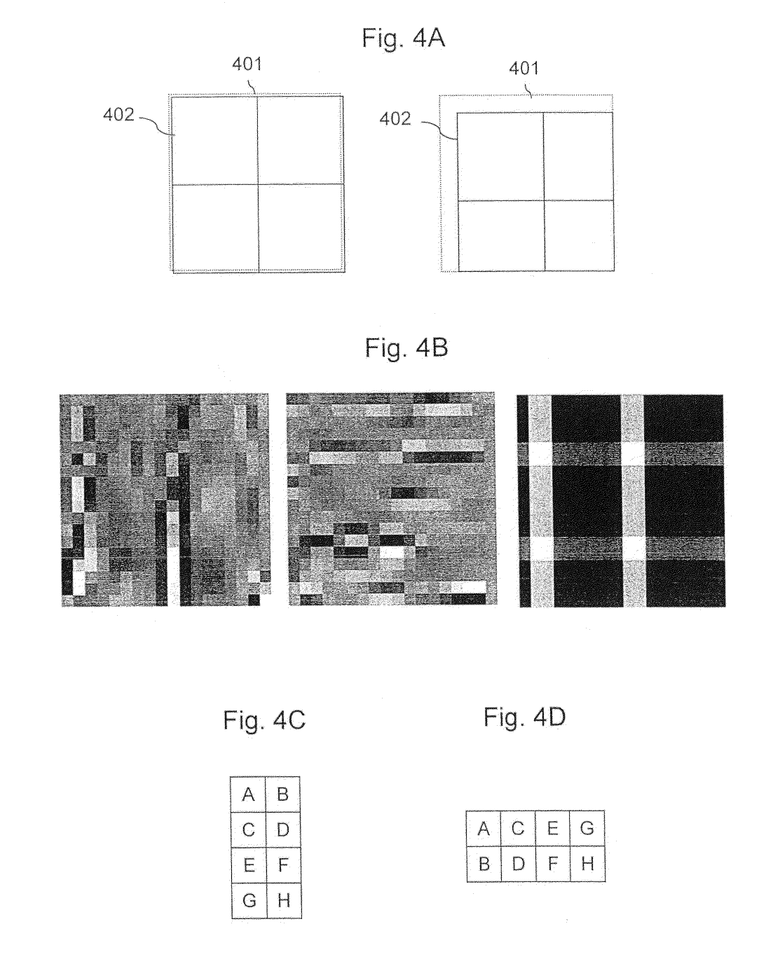

FIG. 4A shows on the left hand side four 8×8 coding blocks which a motion estimation estimates to be shifted to the right hand side and to the bottom side in the next video frame. As illustrated on the right hand side the blocks in the following video frame may appear shifted with regard to a 16×16 macro-block and block boundaries can appear anywhere inside the macro-block. Within a set of macro-blocks, the underlying block grids can differ from each other. According to the embodiment, the block detector unit 121 scans for block boundaries in each 16×16 macro-block. For example the block detector unit 121 scans for block boundaries of at least four pixels in vertical and horizontal directions. The block detector unit 121 may search correlations in vertical and horizontal detail signals with a perfect block border to obtain the block grid for each macro-block separately.

According an embodiment the block detector unit uses a 4×2 filter to estimate, for every position inside each macro block, at least a first value M1 representing a degree of activity, a second value M2 that typically has a maximum value at a block boundary, and a third value M3 that typically has a minimum value at a block boundary. According to an example the filter taps have the configuration of FIG. 4C for the horizontal coefficients and the configuration of FIG. 4D for the vertical coefficients. The block detector unit 121 may calculate the values M1, M2, M3 and may decide on the basis of the values M1, M2, M3 on whether or not a block boundary is present:

M1=|A|+|B|+|C|+|D|+|E|+|F|+|G|+|H|

M2=|A−B|+|C−D|+|E−F|+|G−H|

M3=|A+B|+|C+D|+|E+F|+|G+H|

According to a further embodiment, the second value M2 is adapted to the activity in the respective macro-block in order to make M2 more reliable for block boundary detection. The adaptation may consider a bias implied by the other structures like texture within the macro-block. For example, a final second value M2 is set equal to that value M2 within the macro-block, for which the ratio M3:M2 exceeds a predefined threshold based on the first value M1. If more than one-second value M2 meet the ratio requirement, that second value M2 linked with the minimum third value M3 may be selected. If more than one second value M2 both meet the ratio requirement and are assigned to the same minimum third value M3, the most frequent position may be selected, in other words, that position that fits this test more times than others. According to another embodiment, the constant may be set equal to 0.5.

FIG. 4B shows an exemplary picture section where the block detector unit receives horizontal details as depicted on the left hand side and vertical details as depicted in the middle and estimates the position of the shifted block boundaries within a macro-block as depicted on the right hand side. Bright areas correspond to high activity and dark areas to low activity.

The de-blocking unit 141 of FIG. 2A uses the detected block position information to equalize the energy of detected block boundaries with the energy of neighbouring areas of the same frequency band. The obtained processed frequency bands show reduced blocking artefacts in the image signal. Generally, the equalization is done only in the high frequency bands (detail signals), but not in the lowest frequency band (approximation signals). However, the information about block boundaries may be carried over to other frequency bands, i.e. block position information obtained from a particular frequency band can also be used for equalization of another frequency band.

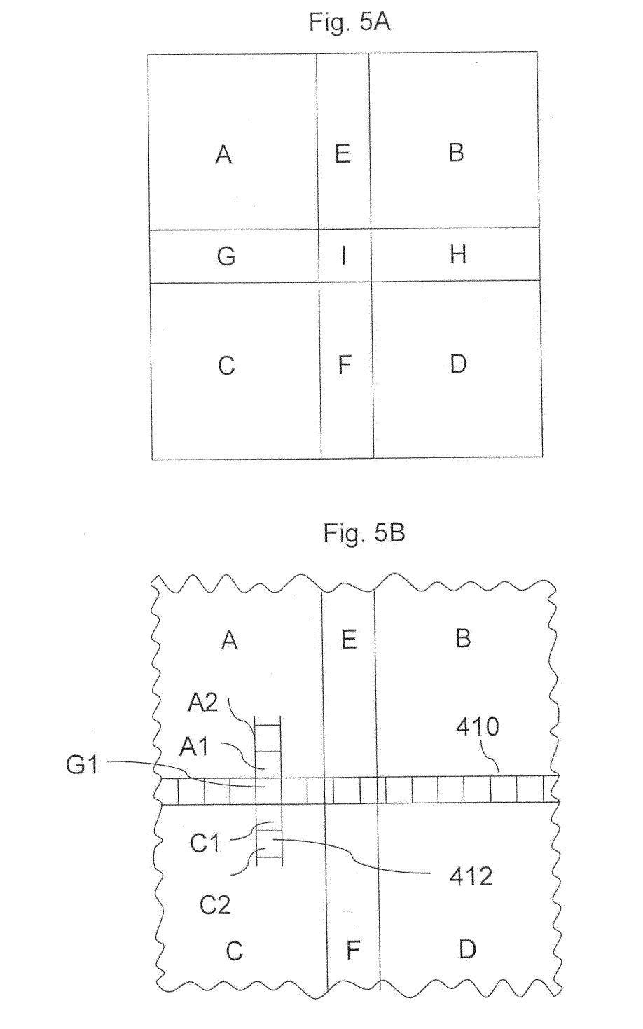

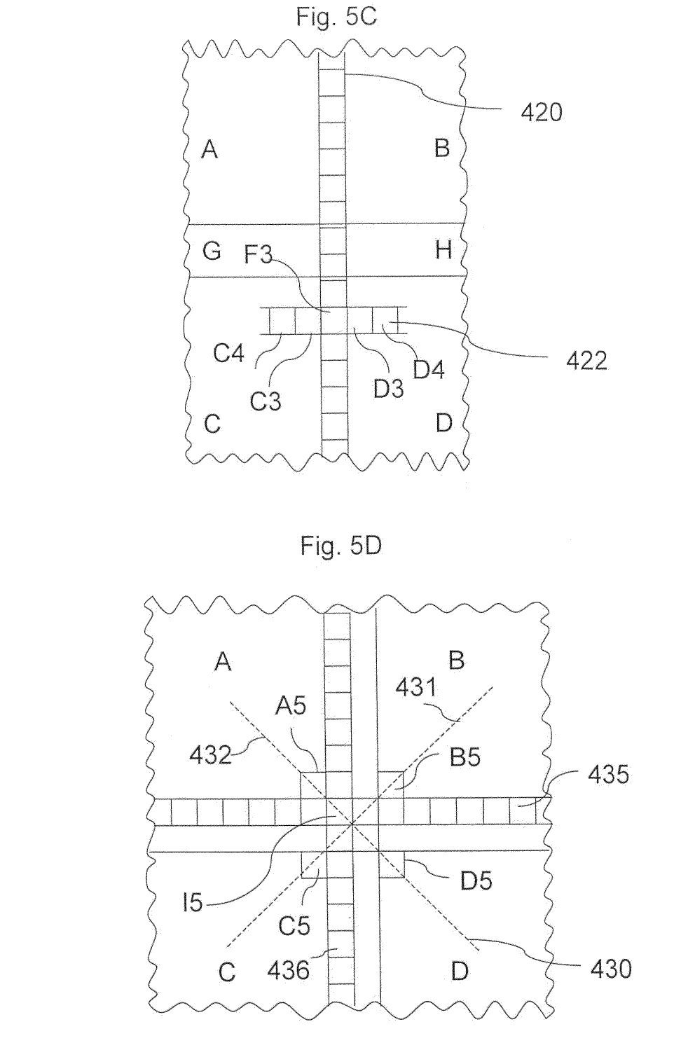

FIGS. 5A to 5D refer to details of the de-blocking as performed by the de-blocking unit 141. FIG. 5A shows a section of an image of a high frequency band obtained by wavelet decomposition in which block boundaries have been identified. The image section is divided into image areas A, B, C, D without any block boundaries and image areas E, F, G, H, I where block boundaries have been identified. The block boundaries may have been enlarged to result in block boundary areas E, F, G, H, I with a width of more than one pixel. The areas E, I, F represent a vertical block boundary, the areas G, I, H represent a horizontal block boundary and the area I represents a block boundary crossing.

The general idea for de-blocking is to equalize the energy of detected block boundaries with the energy of neighbouring areas on both sides of the block boundary. FIG. 5B illustrates de-blocking of a horizontal block boundary 410, i.e. a block boundary along the areas G, I, H. The de-blocking unit 141 equalizes the energy of the detected block boundaries with the energy of reference areas at both sides of the block boundary. The reference areas directly adjoin to the block boundary. According to an embodiment the reference areas are arranged in directions perpendicular to the detected block boundary. For example, the energy of pixel G₁ of the horizontal block boundary 410 is equalized with the energy of neighbouring pixels of the areas A, C, for example with pixels of a column 412 perpendicular to the block boundary 410 and including pixel G₁. According to an embodiment the de-blocking unit uses at least the energy of the directly adjoining pixels A₁ and C₁ for the equalization of pixel G₁. In other embodiments, the energy of two or more directly adjoining pixels of the column 412 in both neighbouring areas A and C is used for the equalization. For example, the energy of all pixels of said column 412 in the two neighbouring reference areas A and C is used for equalizing. The two neighbouring reference areas may correspond to blocks, for example 8×8 blocks. According to another embodiment equalization of the energy of pixel G₁ is based of the complete areas A and C and all pixels of the block boundary area G, wherein A and C may correspond to blocks, for example 8×8 blocks. Equalization may or may not also consider further distant areas, e.g. further adjoining blocks. A column- or row-based equalization may support maintaining orthogonal textures.

According to an embodiment, for equalizing the energy of detected block boundaries the mean, median, maximum or minimum of the energy of directly neighbouring areas, portions of neighbouring areas, or blocks may be used. Other embodiments may weight the pixel values in dependence on their distance to the block boundary, for example inverse proportional to the distance.

FIG. 5C shows an example of de-blocking at a vertical block boundary 420. Generally, the procedure is the same as discussed with respect to the horizontal block boundary 410 in FIG. 5C. Considering a certain pixel F₃ of the detected block boundary 420 the de-blocking unit may equalize energy of this pixel F₃ on the basis of the energy of neighbouring pixels, particularly of pixels of a row 422 extending in a direction perpendicular to the block boundary 420. For instance, in an embodiment, the energy of two directly adjoining pixels C₃ and D₃ is used for the equalization. Other embodiments may provide to consider the energy of two or more (or all) pixels of the row 422 in the areas C and D for equalization. In still another embodiment the de-blocking unit uses the energy of all pixels of the complete areas C and D for equalisation. The areas C and D may correspond to blocks, for example 8×8 blocks.

FIG. 5D illustrates an embodiment for de-blocking at a block boundary crossing in area I. An energy of a pixel I₅ of the block boundary crossing may be equalized by use of the energy of pixels from the neighbouring areas A, B, C, D, for example based on such pixels that are substantially arranged in directions of the bisecting lines 431, 432 of said block boundary crossing. For example, for equalization of the energy of pixel I₅ the energy of neighbouring pixels A₅, B₅, C₅ and D₅ is used. According to other embodiments the energy of more pixels of the areas A, B, C, D, for example energy of the pixels closest to the pixel I₅ or the boundary crossing, or, in still another embodiment, of all pixels of those areas or blocks is used.

In still another embodiment the energy of pixel I₅ is equalized by use of the energy of pixels of the same row 435 and column 436. Since the pixels of this row 435 and this column 436 also adjoin to block boundaries, an embodiment provides to equalize them first as explained above with reference to FIGS. 5B and 5C. In a subsequent step the energy of the pixel I₅ or, the energy of all pixels of a block boundary crossing is equalized by use of the equalized energy of those neighbouring areas of a vertical and a horizontal block boundary that includes the pixel of the row and column leading through said block boundary crossing.

According to another embodiment the de-blocking unit equalizes the energy of the pixels of the block boundary crossing with the energy of the complete areas A, B, C, D, wherein these areas may correspond to blocks, for example 8×8 blocks, and/or the complete areas E, F, G, H.

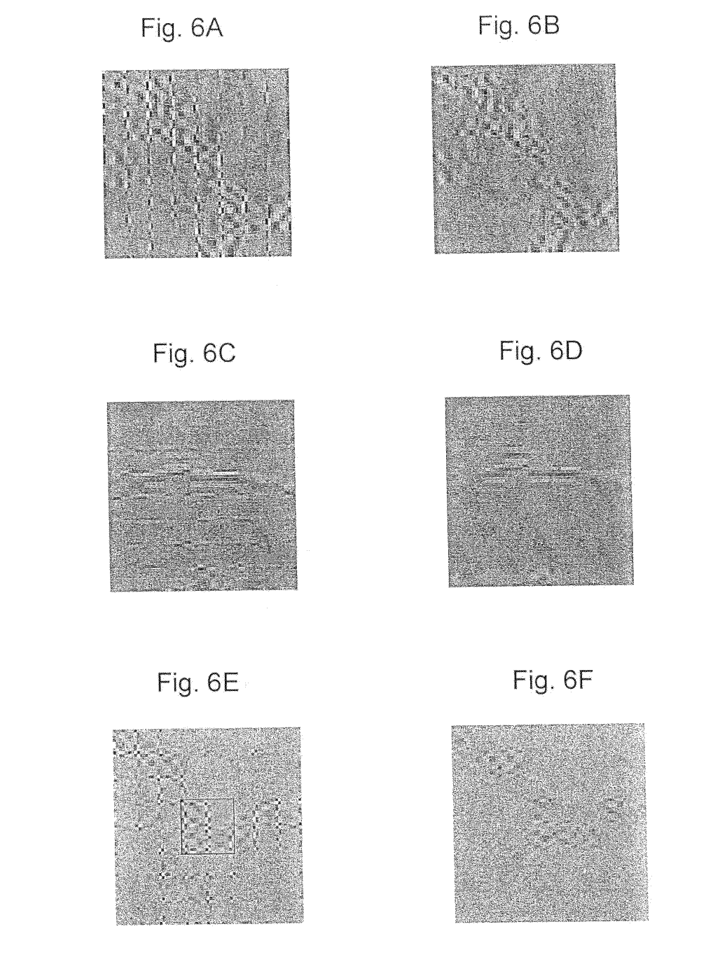

FIGS. 6A to 6E show exemplary images illustrating the effect of the de-blocking performed by the de-blocking unit 141 of FIG. 2A. FIG. 6A shows an image where vertical block boundaries are clearly visible. These block boundaries are much less visible in the image shown in FIG. 6B in which vertical block boundaries have been smoothed by de-blocking as described above. FIG. 6C shows an image with clearly visible horizontal block boundaries, which have been smoothed by de-blocking in the image shown in FIG. 6D. FIG. 6E shows an image with clearly visible diagonal details, i.e. including horizontal and vertical block boundaries and block boundary crossings, which have been smoothed by de-blocking in the image shown in FIG. 6F.

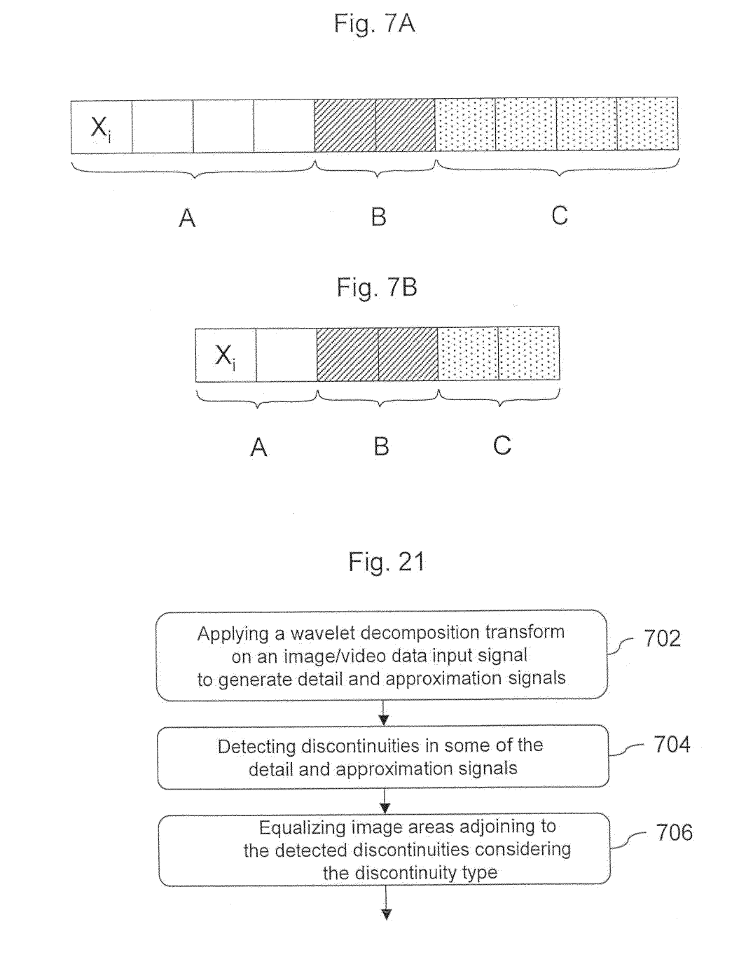

FIGS. 7A and 7B show pixel rows of different numbers. The areas B are related to the block boundaries. The dimension of the area B is related to the wavelet type, e.g. a Le Gall 5/3 wavelet, which provides a block boundary expansion of two pixels in the first wavelet iteration. Going further with the decomposition causes a larger expansion and then a larger block boundary area B may be considered.

In the following explanation, an area will be indicated with a capital letter, A, as well known in the set theory, and a lowercase letter, a, will refer to the absolute moment (or energy) of the first order of the pixels which belong to the correspondent capital letter.

Three different examples (there are further examples available) of energy calculation are:

$$a = {\sum }_{x ∈ A}^{ } \frac{\vert x \vert}{‖ A ‖} , b = {\sum }_{x ∈ B}^{ } \frac{\vert x \vert}{‖ B ‖} , c = {\sum }_{x ∈ C}^{ } \frac{\vert x \vert}{‖ C ‖}$$

$$a = \vert {x}_{1} - {x}_{2} \vert , {x}_{i} ∈ A , b = \vert {x}_{1} - {x}_{2} \vert , {x}_{i} ∈ B , c = \vert {x}_{1} - {x}_{2} \vert , {x}_{i} ∈ C$$

$$a = {\sum }_{{x}_{i} ∈ A}^{ } \frac{\vert {x}_{i} - {x}_{i + 1} \vert}{n} , b = {\sum }_{{x}_{i} ∈ B}^{ } \frac{\vert {x}_{i} - {x}_{i + 1} \vert}{n} , c = {\sum }_{{x}_{i} ∈ C}^{ } \frac{\vert {x}_{i} - {x}_{i + 1} \vert}{n} ,$$

where n is the number of sums.

Some of available examples of equalization formulas are:

$$x = x \cdot \frac{a + b}{2 c} if x ∈ C$$

$$x = x \cdot \frac{min ( a , b )}{c} if x ∈ C$$

$$x = x \cdot \frac{max ( a , b )}{c} if x ∈ C$$

$$x = x \cdot \frac{median ( a , b , c )}{c} if x ∈ C$$

It is also possible to integrate more equalization formulas depending on other image information, as for example x∈edge or x∉edge.

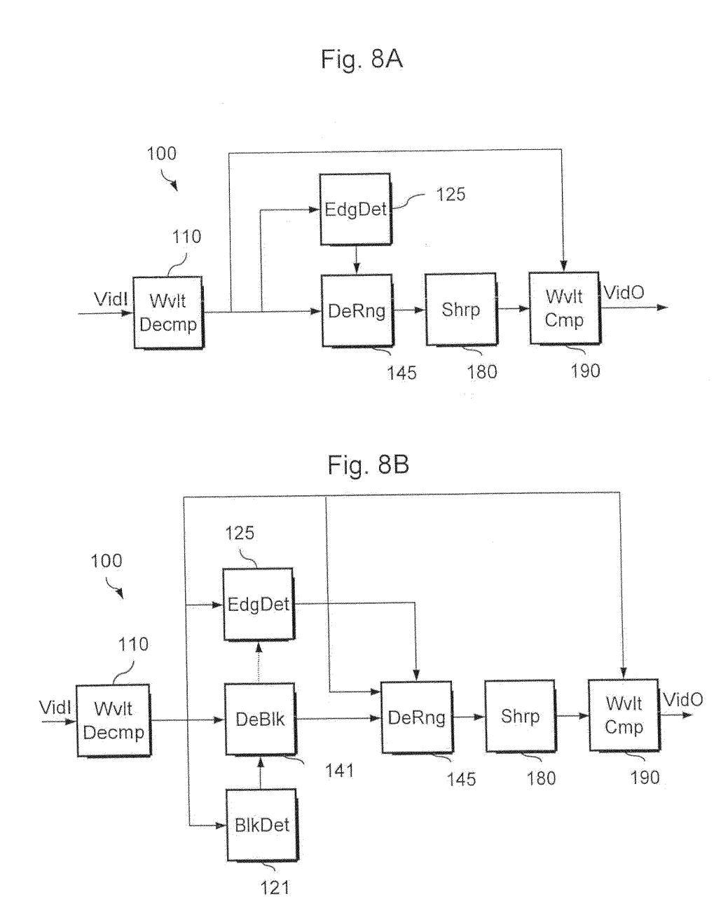

FIG. 8A refers to an embodiment of the image processing unit of FIG. 1 related to the reduction of artefacts occurring in the vicinity of image edges like object contours in the imaged scene. An image edge detection unit 125 evaluates one or more of the output detail and approximation signals output by the wavelet decomposition unit 110 as evaluation signals. According to an embodiment, the image edge detection unit 125 evaluates a first order low-frequency band or a sub-band derived from the first order low-frequency band or a sub-band derived from the first order high-frequency band and outputs position information identifying the found image edges. Since the low-frequency band represents a low-pass version of the original signal, noise and, as a consequence, false positives during edge detection can be reduced. On the other hand, the block boundary detection as described above relies on a type of pattern recognition, which is less sensitive to noise such that block boundary detection rather relies on detail signals than on approximation coefficients.

For example, the image edge detection unit 125 may use the first stage approximation signal. The position information may be, by way of example, an edge map including binary entries for each pixel position. In the edge map, a first binary value, e.g. “1” may indicate that the pixel is assigned to an edge, and a second binary value, e.g. “0” may indicate that the pixel is not assigned to an edge. A de-ringing unit 145 receives the edge map as well as at least one of the signals output by the wavelet decomposition unit 110, for example that or those bands from which the edge map has been derived. The de-ringing unit 141 performs an equalization process equalizing the energy at the edges with that of reference areas, for example blocks in the vicinity and at the same side of the edge. According to another embodiment, the de-ringing unit 145 uses only high-frequency bands, for example signals derived from first stage detail signal.

The image processing unit 100 of FIG. 8A refers to an embodiment that does not necessarily combine image edge processing and block boundary processing or may subject both image edges and block boundaries to the same artefact reduction scheme. Instead, the image processing unit 100 of FIG. 8B performs both image edge processing and block boundary processing that differs from the edge processing exploiting the fact that they have different causes and that block boundaries can reliably be distinguished from image contour lines. According to an embodiment that combines image edge and block boundary processing, a de-blocking unit 141 outputs de-blocked signals to the de-ringing unit 145 and the de-ringing unit 145 may perform de-ringing on the basis of at least one of the de-blocked signals. Edge detection may or may not be based on de-blocked signals.

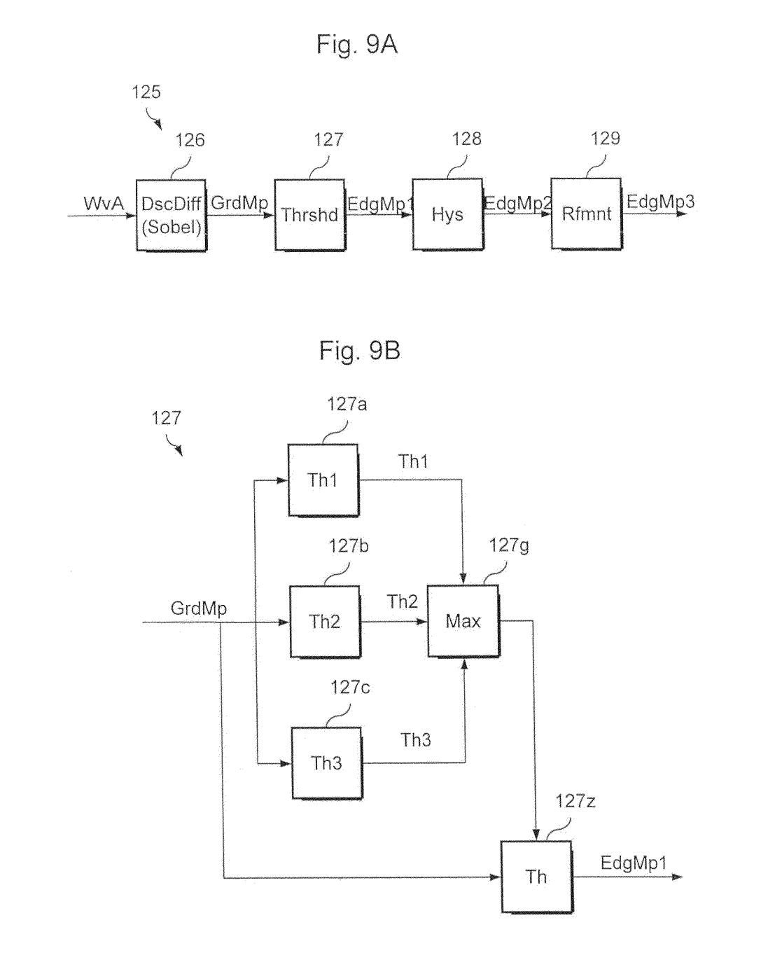

FIG. 9A refers to an embodiment of the image edge detection unit 125 of FIGS. 8A and 8B. A differentiator unit 126 of the image edge detection unit 125 receives one or more of the signals output by a wavelet decomposition unit 110. According to an embodiment, the differentiator unit 126 receives one low-frequency band, for example the first approximation coefficients output by the low-pass filter of the first filter stage or the LL-signal of a two-dimensional WPD. For each of the received signals, the differentiator unit 126 performs a differentiation operation assigning high values to pixels in areas with steep energy transitions and low values to pixels in areas with smooth energy transitions. Due to the low-pass filtering from which the approximation or LL signal emerges, areas with a high-density texture tend to appear blurred in the approximation or LL signal. The differentiator unit 126 may apply a discrete differentiation operator computing an approximation of the gradient of an image intensity function of the image represented by the current input data signal. According to an embodiment, the differentiator unit 126 may apply a Sobel operator, for example the 5×5 Sobel operator for obtaining a gradient map of the image represented by the current input data signal. High values in the gradient map indicate presence of steep transitions in the original image. However, also texture may still be visible in the gradient map. According to an embodiment, the image edge detection unit 125 further includes an adaptive threshold unit 127 for deriving, from the gradient map, a coarse binary edge map.

The image edge detection unit 125 may further include a hysteresis unit 128 that tracks edges into areas where the threshold unit 127 has not detected an edge to generate an improved edge map. A refinement unit 129 may delete single structures from the improved edge map, for example point structures and other non-typical edge patterns in order to obtain a corrected edge map.

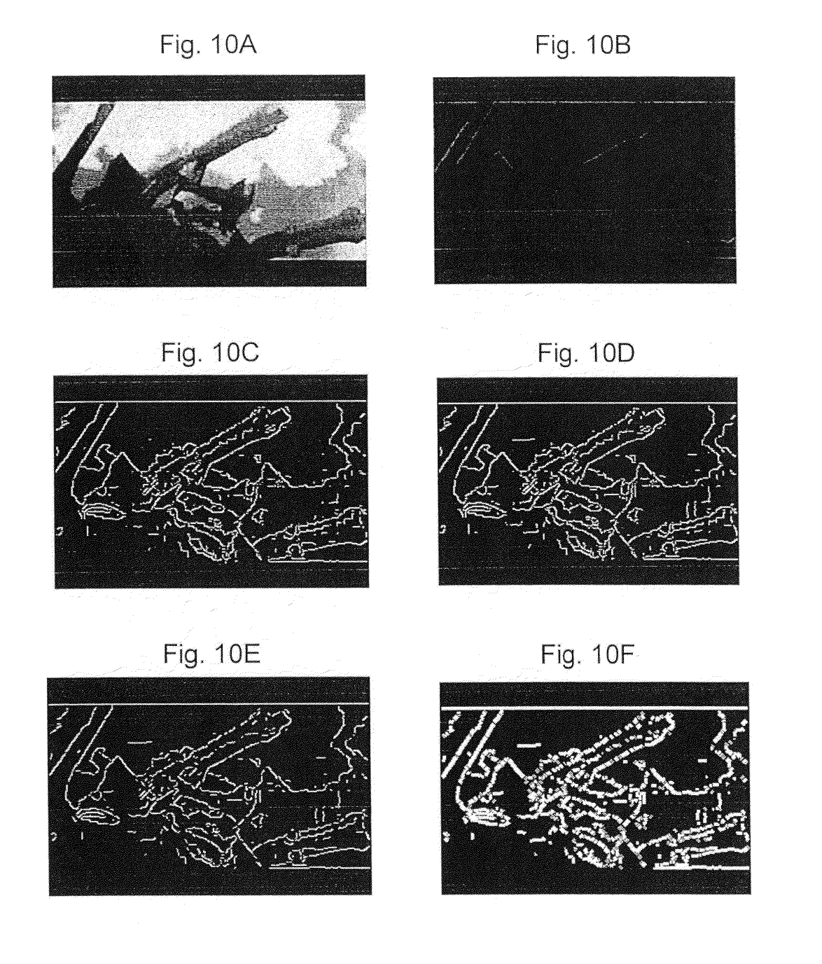

FIGS. 10A to 10E illustrate the process performed by the image edge detection unit 125 of FIG. 9A. FIG. 10A shows the 1^{st} stage approximation signal (LL-signal) of an exemplary input image coded by an input data signal. FIG. 10B shows a corresponding gradient map generated using a 5×5 Sobel operator. FIG. 10C shows a coarse edge map generated by a threshold comparing the values in the gradient maps with an adaptive threshold as described in more detail below. FIG. 10D shows that where threshold unit 127 only detects a part of a contour line, the hysteresis extension reveals more information about the whole contour or at least about a longer section of the contour line. FIGS. 10E and 10F show that a refinement process can remove point-like structures.

FIG. 9B shows details of an embodiment of the threshold unit 127 of FIG. 9A. The gradient map output by the differentiator unit 126 is supplied to at least two, for example three, threshold calculator units 127a. Each threshold calculator unit 127a calculates, for each gradient map, specific threshold values Th1, Th2, Th3. At least one, for example two, of the threshold values Th1, Th2, Th3 may be position-dependent. According to an embodiment, one of the threshold values Th1, Th2, Th3 is not position-dependent. For example, a first threshold Th1 may be the mean value of the activity of the absolute gradient function |G|. A second threshold Th2 may be computed for each block of the currently processed image or video frame, wherein the block size may be 8×8, and may be the mean activity |G| of the block, by way of example. A third threshold Th3 may be computed for an area comprising the block of the second threshold Th2 and the eight neighbouring blocks, for example for 24×24 pixels.

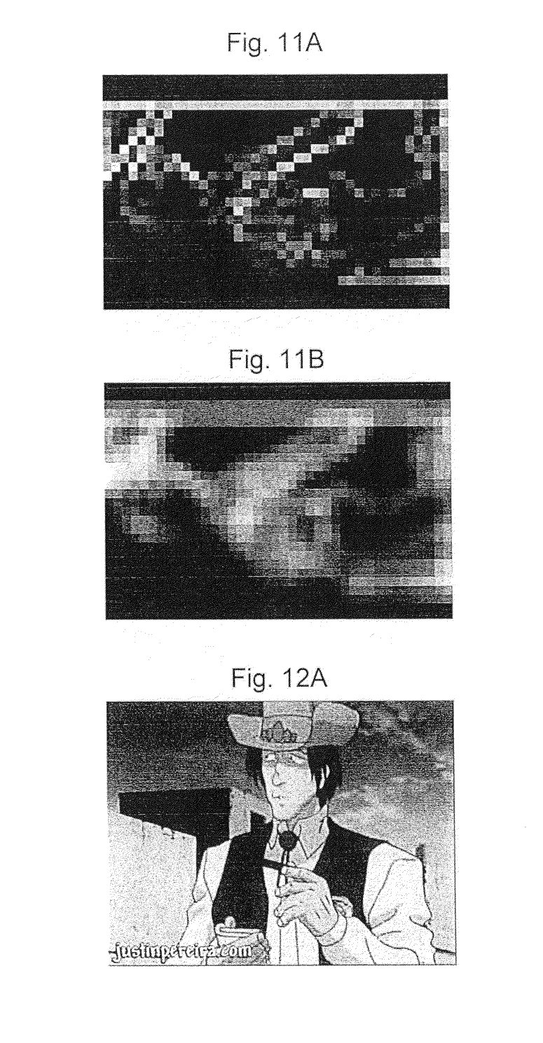

FIG. 11A shows the distribution of the second threshold values Th2 for the approximation signal of FIG. 10A. FIG. 11B shows the distribution of the third threshold values Th3 for the above embodiment. Bright areas/blocks correspond to pixel blocks, where an increased high threshold value is used for generating the edge map, whereas in dark blocks the second and third thresholds may be lower than the mean activity |G| of the image. For each area in the gradient map, a setting unit 127g selects the maximum value of the available two, three or more thresholds Th1, Th2, Th3 and sets the threshold of a comparator unit 127z according to the position of the currently evaluated point in the gradient map. The comparator unit 127z assigns, in an edge map, a first value representing an edge, if the respective value in the gradient map exceeds the threshold set by the setting unit 127g.

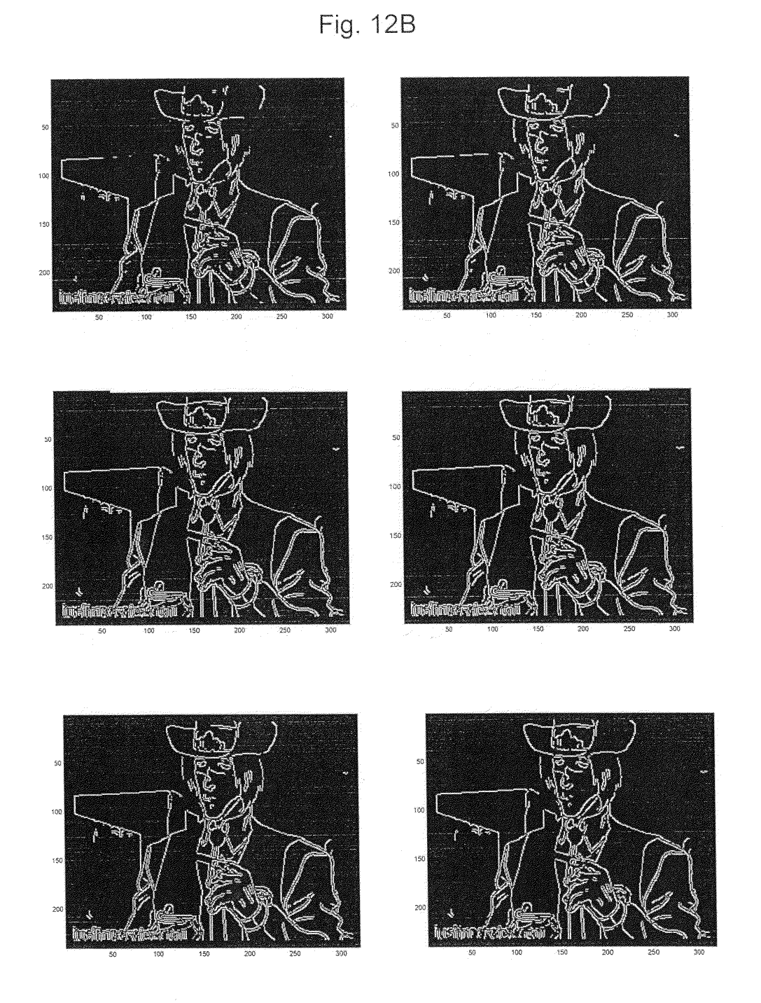

According to an embodiment, the hysteresis unit 128 provides a further scanning for extensions of edges detected by a first run of the threshold unit 127. According to an embodiment the hysteresis unit 128 provides at least one further scan at a lowered threshold, wherein a pixel which activity exceeds the lowered threshold and which directly adjoins to a pixel previously detected as an edge may be defined as edge pixel, too. According to an embodiment, the hysteresis unit 128 may control the comparator unit 127z of the threshold unit 127 of FIG. 9B to contribute to the further scans. According to another embodiment, the additional scans are only performed for the neighbouring ones of such pixels of the approximation signal that have been previously detected as edge pixels. The further scans can be repeated several times, for example four times, wherein the threshold value may be increased again where a previous lowering shows ambiguous results. FIG. 12B shows the results of four additional scans applied to the output signal of a threshold unit supplied with an approximation signal obtained from the image of FIG. 12A.

The image edge detection process may be implemented in parallel to or merged with the block detection and de-blocking process. According to an embodiment, image edge detection and de-ringing is performed after de-blocking has been performed. For example, the image edge detection unit may receive a signal output by the de-blocking unit. In accordance with a further embodiment, the de-blocking unit outputs a de-blocked approximation signal and the edge detection unit uses the de-blocked approximation signal for detecting image edges.

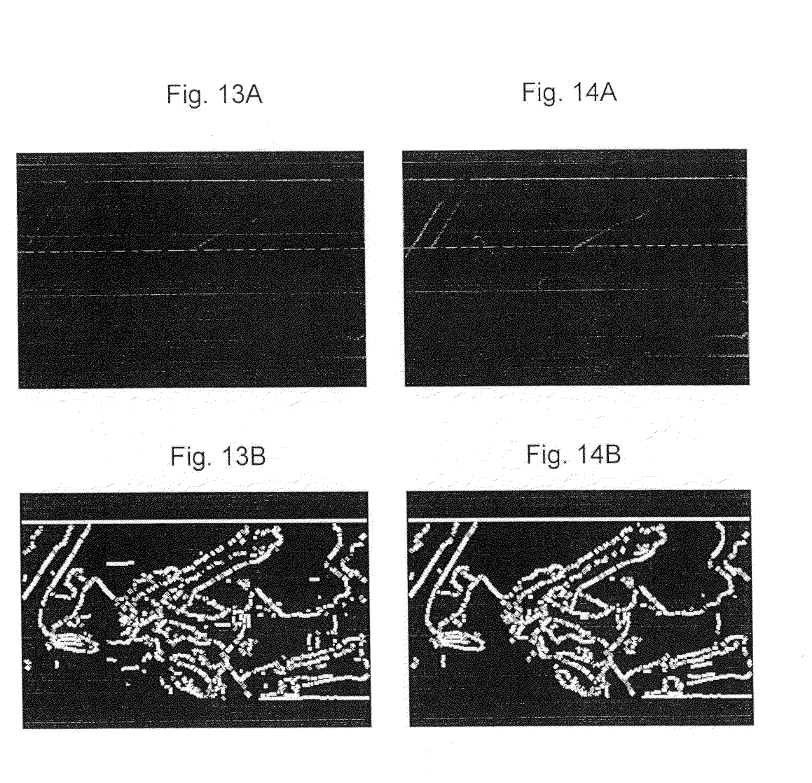

FIG. 13A shows a gradient map derived from an approximation signal which the wavelet decomposition unit 110 of FIG. 8A outputs in response to an input data signal descriptive for the image underlying the approximation signal of FIG. 10A. FIG. 13B shows an edge map derived from the gradient map of FIG. 13A. By contrast, FIG. 14A shows a gradient map derived from a de-blocked approximation signal which is output by the de-blocking unit 141 of FIG. 8B in response to the same image. Where the edge map of FIG. 13B indicates discontinuities which are not contour lines but block boundaries that would undergo the same equalization procedure as actual image edges, embodiments performing edge detection on de-blocked approximation or detail signals may distinguish image edges from block boundaries and can therefore handle them differently thereby minimizing adverse effects which may result from applying de-ringing schemes on block boundaries.

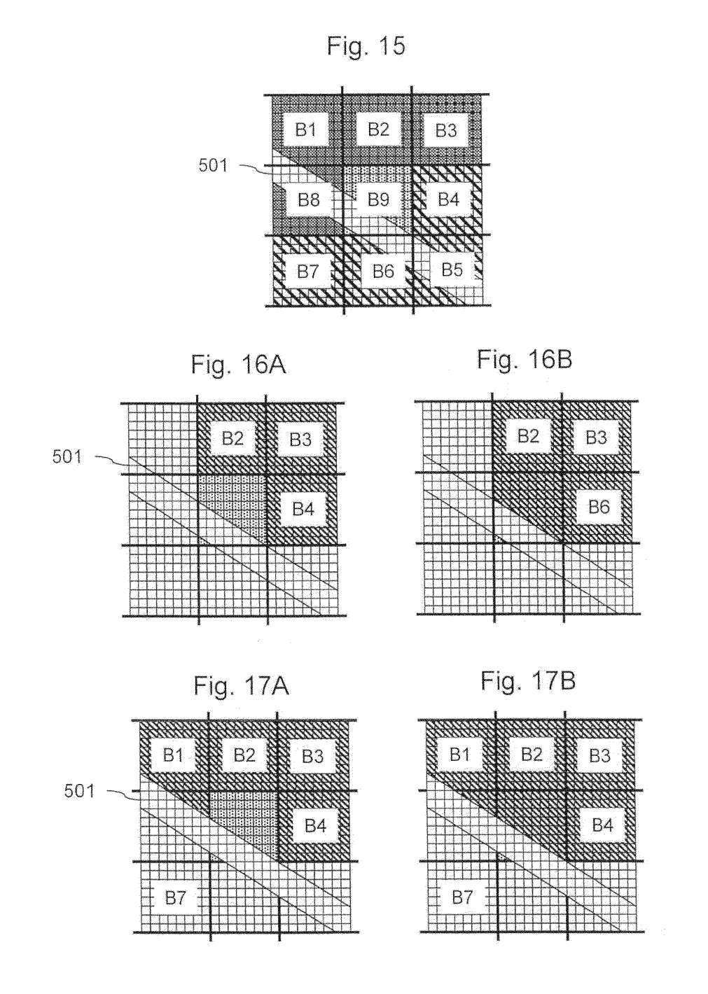

FIG. 15 shows an image section containing a contour line 501 passing through sub-areas B1, B8, B9, B6 and B5. According to an embodiment, the sub-areas may be squares, for example 8×8 pixel squares. The sub-areas may correspond to pixel blocks or portions of pixel blocks. The de-ringing unit 145 of FIGS. 8A and 8B may scan the image along a scan direction for contour lines. In the example of FIG. 15, the scan starts in the top left image corner and proceeds row by row. When the scan arrives at sub-area B9, sub-areas B1, B2, B3 and B8 have already been scanned for as indicated by the dark shading and sub-area B1, which directly adjoins to the contour line 501, has already been subjected to an equalizing process with regard to the contour line 501. Sub-areas B4, B7, B6 and B5 have neither been scanned nor equalized when the scan arrives at sub-area B9.

According to an embodiment the de-ringing unit 145 of FIGS. 8A and 8B, when equalizing the first sub-area B9, does not consider sub-areas previously equalized with regard to the same contour line. For example, the de-ringing unit 145 of FIGS. 8A and 8B equalizes a portion of the currently scanned sub-area B9 at a first side of the edge using reference sub-areas that directly adjoin to the currently scanned area at the same side of the contour line but not having been subjected to a previous equalization with regard to the same contour line. In accordance with another embodiment, none of the reference sub-areas directly adjoin to the contour line 501. According to a further embodiment, the values for the currently scanned sub-area B9 are not considered for equalization, since sub-area B9 may be infected by ringing artifacts.

FIGS. 16A and 16B refer to an example, where the de-ringing unit 145 of FIGS. 8A and 8B does not consider blocks previously equalized and bases equalization of a portion of the first sub-area B9 above the contour line 501 only on the sub-areas B2, B3 and B4, wherein none of those sub-areas directly adjoin to the contour line 501. FIG. 16B shows that another portion of the sub-area B9 below the contour line 501 is not affected by the equalization of the portion above the contour line.

According to a further embodiment the de-ringing unit 145 of FIGS. 8A and 8B considers also such sub-areas directly adjoining to the contour line 501 that have been previously equalized with regard to the same contour line. For example, the de-ringing unit 145 of FIGS. 8A and 8B equalizes a portion of the currently scanned first sub-area B9 at a first side of the edge using all sub-areas that directly adjoin to the currently scanned sub-area at the first side apart from sub-areas that both adjoin to the same contour line and have not been yet subjected to equalization.

FIGS. 17A and 17B refer to an example, where the de-ringing unit 145 of FIGS. 8A and 8B considers both sub-areas previously equalized and sub-areas not directly adjoining to the contour line 501. A further embodiment refers to a second scan in the opposite direction such that other sub-areas may be considered for equalization of the first sub-area B9. The final equalization may be a combination of the results of the first and second scan.

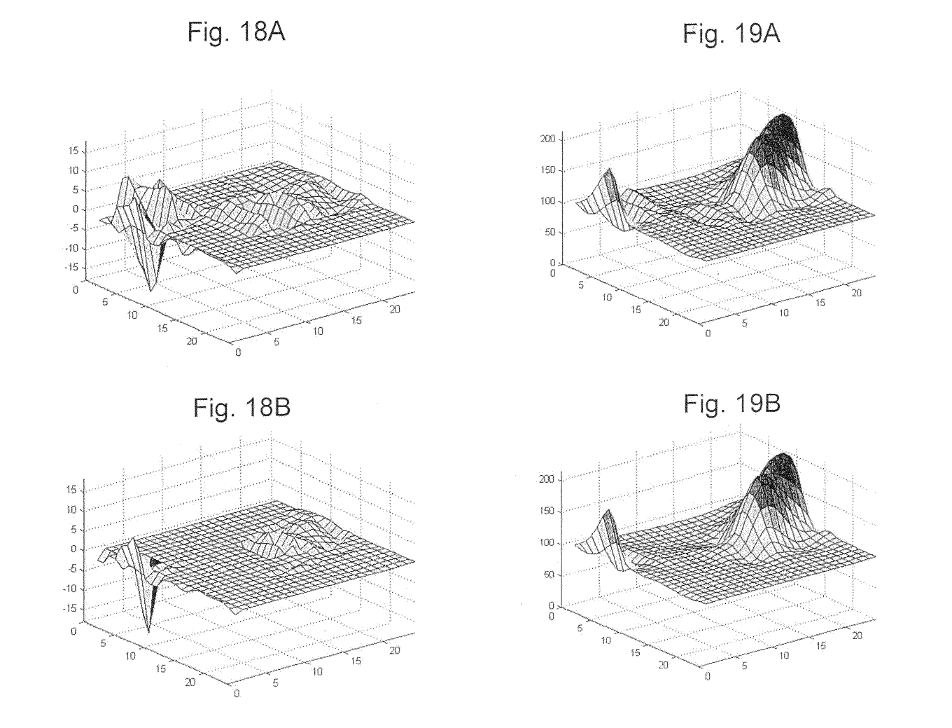

FIG. 18A is a 3D-plot of horizontal details of an image section of an exemplary picture. FIG. 18B shows the corresponding corrected horizontal details output by a de-ringing unit as discussed above and receiving the horizontal details of FIG. 18A.

FIG. 19A is a 3D-plot of the image section of FIG. 18A. FIG. 19B shows the effect of the corrected horizontal details of FIG. 18B on the visible image. The equalization process selectively suppresses ringing artifacts but keeps the texture in the imaged objects.

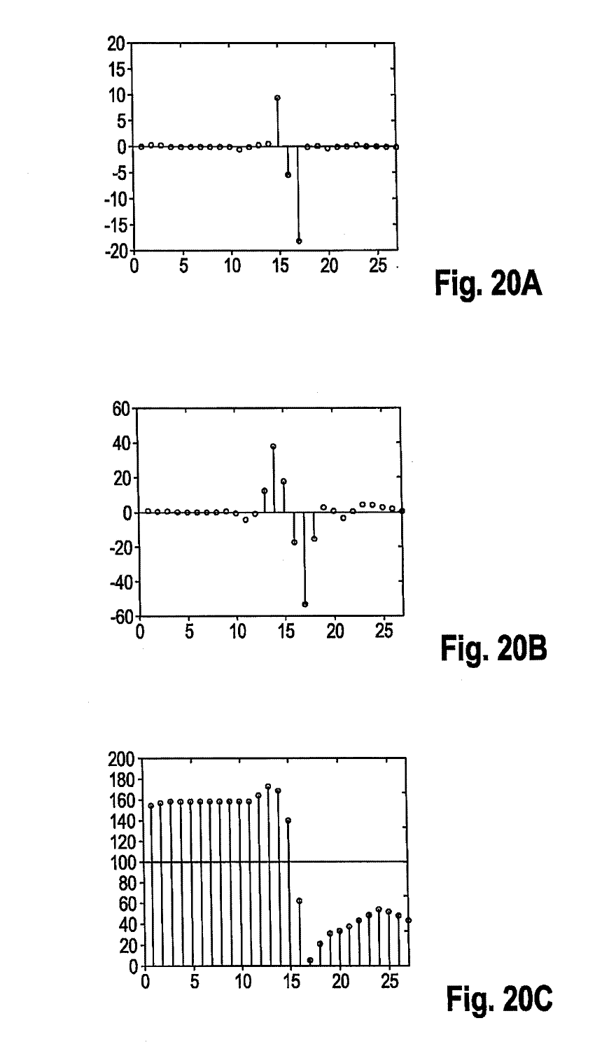

The sharpness enhancement unit 180 of FIG. 1B uses a subset of the frequency bands to improve image sharpness. For example, the sharpness enhancement unit 180 may exchange sharpness information between the frequency bands, e.g. vertical and horizontal detail signals, or detail and approximation signals in order to highlight contour lines. According to an embodiment, the sharpness enhancement unit 180 may receive an edge map and may increase the maximum and the minimum values along the edge in the first two wavelet decompositions in the orthogonal direction of the decomposition. FIG. 20A shows sub-band edge peaking in first vertical details, FIG. 20B sub-band edge peaking in second vertical details and FIG. 20C sub-band edge peaking in the image. Where usually a simple sharpness enhancement increases the mid frequencies and hence tends to introduce again ringing artifacts, the sharpness enhancement unit 180 applies a special processing to edges in order to enhance the edge without re-introducing ringing artifacts.

The image processing unit and each of the sub-units thereof may be realized in hardware, in software or as a combination thereof. Some or all of the units and sub-units may be integrated in a common package, for example an IC (integrated circuit), an ASIC (application specific integrated circuit) or a DSP (digital signal processor). According to an embodiment, the image processing unit with all its sub-units is integrated in ones integrated circuit.

The present embodiments allow YUV processing, where Y U V are the luminance and chrominance channels. In this case the information about blocking may be derived from the Y channel, and the U and V channels are processed accordingly like the Y channel.

Starting from the baseband domain, the embodiments exploit the wavelet decomposition in order to perform a better de-blocking, without any knowledge of a preceding encoding. The proposed method reduces blocking while keeping the texture, which normally does not apply to conventional baseband methods. The process is memory centric, which is clearly useful for software applications running on a PC, where usually the memory is not a real problem, while the CPU might be used by several, uncontrollable tasks. This method keeps the computational load low, while using more memory. This approach makes it suitable for PC application.

In the claims, the word “comprising” does not exclude other elements or steps, and the indefinite article “a” or “an” does not exclude a plurality. A single element or other unit may fulfil the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

The embodiments of the invention provide an analysis of the wavelet domain for edge and block grid detection. De-blocking is based on equalization of the block boundaries in the wavelet domain. De-ringing is based on equalization between blocks in the wavelet domain. De-blocking and De-ringing can be combined with each other and with sharpness enhancement in the wavelet domain. Since the wavelet domain highlights edges, they can be detected easily. Only frequencies of interest are processed. The approach can be easily combined with other wavelet-based image enhancement processes concerning contrast, Hue values and saturation.

1. An image processing unit (100) comprising
a wavelet decomposition unit (110) configured to apply a wavelet decomposition on an input data signal descriptive for an image, wherein at least one approximation and at least one detail signal are generated;
a discontinuity detection unit (120) configured to detect discontinuities in at least one evaluation signal selected from the approximation and detail signals, the discontinuities comprising image edges and block boundaries; and
an artefact reduction unit (140) configured to reduce edge-induced artefacts by equalizing pixel values in image areas identified by the detected discontinuities in at least one of the approximation and detail signals to obtain at least one corrected approximation or detail signal.

2. The image processing unit according to claim 1, further comprising
a wavelet composition unit (190) configured to combine the at least one corrected approximation or detail signal and further approximation and/or detail signals output by the wavelet decomposition unit (110) to generate an output data signal.

3. The image processing unit according to claim 1, wherein
the discontinuity detection unit (120) comprises a block detection unit (121) configured to identify block boundaries in a first evaluation signal of the at least one evaluation signals, wherein the first evaluation signal is a detail signal, the block detection unit (121) configured to scan for correlations between areas of high activity.

4. The image processing unit according to claim 3, wherein
the block detection unit (121) is configured to identify block boundaries within single macro-blocks independently from other macro-blocks.

5. The image processing unit according to claim 3, wherein
the artefact reduction unit (140) comprises a de-blocking unit (141) configured to equalize energy at the detected block boundaries with energy of neighbouring areas of at least one of the detail and approximation signals to obtain a de-blocked detail or approximation signal, wherein blocking artefacts in a vicinity to the detected block boundaries are reduced.

6. The image processing unit according to claim 5, wherein
the de-blocking unit (141) is configured to equalize the energy of a detected block boundary with the energy of two directly neighbouring areas that are arranged in directions perpendicular to the detected block boundary.

7. The image processing unit according to claim 1, wherein
the discontinuity detection unit (120) comprises an image edge detection unit (125) configured to detect image edges in a second evaluation signal of the at least one evaluation signal, the image edge detection unit (125) comprising a differentiator unit (126) configured to obtain a gradient map from the image and an adaptive threshold unit (127) configured to apply a position- and activity-dependent threshold to the gradient map to obtain a binary edge map of the image.

8. The image processing unit according to claim 7, wherein
the second evaluation signal is an approximation signal.

9. The image processing unit according to claim 7, wherein
the image edge detection unit (125) comprises a hysteresis unit (128) configured to evaluate edges in the binary edge map output by the threshold unit (127) by scanning entries in the gradient map adjoining to detected edges with a lowered threshold.

10. The image processing unit according to claim 7, wherein
the artefact reduction unit (140) comprises a de-ringing unit (145) configured to receive the binary edge map and to apply an equalization scheme equalizing energy in a first sub-area adjoining to a first side of an edge identified by the edge map using reference sub-areas arranged at the first side and adjoining to the first sub-area.

11. The image processing unit according to claim 10, wherein
the de-ringing unit (145) is configured to equalize energy in the first sub-area using reference sub-areas arranged at the first side, adjoining to both the first sub-area and the edge.

12. The image processing unit according to claim 10, wherein
the sub-areas correspond to blocks of 8×8 pixel.

13. The image processing unit according to claim 1, wherein
the approximation and detail signals correspond to frequency bands of a wavelet package decomposition.

14. The image processing unit according to claim 1, wherein
the artefact reduction unit (140) is configured to determine an energy of an area by determining the sum of the absolute values of the pixel values of the respective area, the sum of the square values of the pixel values of the respective area, or the sum of the absolute differences of consecutive pixel pairs with or without mean values of neighbouring areas added.

15. A method of operating an image processing unit, the method comprising
decomposing, by a wavelet decomposition scheme, an input data signal descriptive for an image into at least one approximation and one detail signal,
detecting discontinuities in at least one evaluation signal selected from the approximation and detail signals, and
equalizing energy of areas identified by the detected discontinuities with energy of neighbouring areas to obtain at least one corrected detail or approximation signal.

16. The method of claim 15, further comprising
composing the at least one corrected approximation or detail signal and further approximation and/or detail signals obtained by the wavelet decomposition to generate an output data signal.

17. The method of claim 15, wherein
the approximation and detail signals correspond to frequency bands of a wavelet package decomposition.

18. A computer program comprising program code means for causing a computer to perform the steps of said method as claimed in claim 15 when the computer program is carried out on a computer.

19. A computer readable, non-transitory medium having instructions stored thereon which, when carried out on a computer, cause the computer to perform the method as claimed in claim 15.
